(19) United States
(12) Patent Application Publication
(10) Pub. No.: US 2025/0269736 A1
(43) Pub. Date: Aug. 28, 2025

(54) METHOD OF CONTROLLING DRIFT OF VEHICLE

(71) Applicants: HYUNDAI MOTOR COMPANY, Seoul (KR); Kia Corporation, Seoul (KR)

(72) Inventor: Sang Hyup Lee, Hwaseong-si (KR)

(73) Assignees: HYUNDAI MOTOR COMPANY, Seoul (KR); Kia Corporation, Seoul (KR)

(21) Appl. No.: 18/914,837

(22) Filed: Oct. 14, 2024

(30) Foreign Application Priority Data
Feb. 23, 2024 (KR) 10-2024-0026173

(51) Int. Cl. B60L 15/20

(52) U.S. Cl. CPC B60L 15/2036; B60L 2240/18; B60L 2240/22; B60L 2240/423; B60L 2240/461; B60L 2240/465; B60L 2250/26

(57) ABSTRACT

A method of controlling drift of a vehicle in which the vehicle more easily enters, maintains, releases, and transitions drift behavior, includes determining, by a controller, whether a current driving situation of the vehicle is a drift entry situation or a release situation based on vehicle driving information, and generating a drift index configured to indicate a current degree of drift from a determination result, determining, by the controller, a target yaw moment for left and right speed control depending on a driving situation or a braking situation of the vehicle and target yaw moments for drift assistance control depending on a driver input and a vehicle state in the drift entry situation, based on the vehicle driving information, and generating and outputting, by the controller, a target torque of a motor configured to drive each wheel of the vehicle based on the determined target yaw moments.

### CROSS-REFERENCE TO RELATED APPLICATION

The present application claims priority to Korean Patent Application No. 10-2024-0026173 filed on Feb. 23, 2024, the entire contents of which is incorporated herein for all purposes by this reference.

### BACKGROUND OF THE PRESENT DISCLOSURE

### Field of the Present Disclosure

The present disclosure relates to a method of controlling drift of a vehicle. More particularly, it relates to a method of controlling torques of respective wheels in which an electric vehicle equipped with a motor-based drive system may more easily enter, maintain, release, and transition drift behavior.

### Description of Related Art

Drifting is a driving condition of a vehicle in which driving wheels slip using the driving force of the vehicle and thus lead the vehicle to oversteer (OS), and the vehicle is continuously driving by manipulating the steering angle of front wheels in the opposite direction of the turning direction of the vehicle.

For example, to maintain a high escape speed at a corner, the driver may intentionally cause rear wheels to slip while maintaining control of the vehicle to cause an oversteer state of the vehicle, allowing the vehicle to pass through the corner.

Just before cornering, when the vehicle is in a countersteer state in which the slip angle of the rear wheels is greater than the slip angle of the front wheels and the steering angle direction of the front wheels is opposite to the turning direction of the vehicle, the driver may advance an acceleration point to escape the corner while maintaining a high escape speed by first turning the vehicle in the same direction as the turning escape trajectory of the vehicle by maintaining a dynamic equilibrium state during turning, and at the instant time, the driver may finely operate a steering wheel to drive the vehicle in a desired turning direction.

In the case of high performance vehicles, such as sedans, coupes, and sports cars, and rear wheel drive (RWD)-based vehicles having the tendency of sports cars, whether drift driving to increase the fun of driving is feasible is an important marketing point.

However, when a high performance vehicle is provided with an all-wheel drive (AWD) system, the slip angle of rear wheels is reduced due to increase in straightness of the vehicle caused by driving force of front wheels, and thus, it is difficult to perform drift driving of the vehicle.

Therefore, when consumers purchase a vehicle, they conflict between a front engine rear wheel drive (FR)-based two-wheel drive (2WD) vehicle which is a fun vehicle capable of drifting but is disadvantageous in terms of vehicle stability during normal driving, and an FR-based all-wheel drive (AWD) vehicle which is disadvantageous in terms of drifting but has excellent driving stability and traction performance.

While an AWD system implements a torque distribution function between front and rear wheels of a vehicle, but does not perform torque distribution between left and right wheels, a limited-slip differential (LSD) distributes torque to left and right driving wheels to allow the vehicle to easily escape from a rough road, and transmits torque to an external wheel while suppressing slip of an internal wheel in turning of the vehicle to suppress understeer (US) and thus to improve handling performance of the vehicle. The LSD helps implement drift driving of the vehicle.

In view of this, the applicant of the present disclosure filed a patent for a control method regarding drift driving of a vehicle. Korean patent laid-open publication No. 10-2019-0127433 (Publication date: Nov. 13, 2019) (Patent Document 1) filed by the applicant of the present disclosure discloses a control method for implementation of the drift driving state of a vehicle.

The control method included in Patent Document 1 includes inducing, by a controller, slip to reduce a torque of an all-wheel drive (AWD) system distributed to front wheels compared to cases other than a drift mode, when the vehicle enters a turn and is in a power-on state while the drift mode is selected, controlling, by the controller, a slip torque to allow the vehicle to enter drift by adding a slip control torque depending on the lateral acceleration of the vehicle to the torque distributed to the front wheels, when slip of rear wheels of the vehicle occurs, and maintaining, by the controller, a drift state of the vehicle by releasing the torque distributed to the front wheels, when a countersteer state by a driver is confirmed.

Patent Document 1 includes a method of assisting drift control of an AWD vehicle, which has both an AWD function and an LSD function, using an LSD system to allow the vehicle to perform drift driving.

According to the above conventional technology, the LSD system is used to control lateral driving force of the vehicle when drifting. That is, slip of the vehicle is maintained and maintenance of drift of the vehicle is assisted by locking an axle, on which the LSD is mounted, and transmitting driving force to an external wheel to suppress slip of an internal wheel during drifting.

Meanwhile, before motor-based torque vectoring, mechanical or clutch-based torque vectoring technology was mainly developed, and a mechanical limited slip differential (mLSD) and an electronic LSD (eLSD) were mainly used for such torque vectoring. Currently, twin clutches are being actively developed.

These devices include a structure which may transmit torque in both directions by adding a left and right torque distribution module to an open differential (mLSD and eLSD), or a structure which may determine the driving torque of one wheel (twin clutch).

This system is a system which, when driving torque (torque of an engine or an axle motor) exists, may determine torque distribution to left and right wheels within the above torque as the maximum range.

In the case of existing motor torque vectoring control logic and clutch-based torque vectoring control, drift performance is generally secured by synchronizing left and right wheel speeds. In the case of an open differential, spinning of an internal wheel occurs, it is difficult to generate torque of an external wheel which is greater than or equal to torque felt from the internal wheel due to the nature of the differential, a turning yaw moment is reduced as the driving force of the external wheel is lost, and a situation in which the vehicle may not enter drift occurs.

A typical example of the effect of clutch-based drift control is to decrease internal wheel torque and increase external wheel torque through left and right wheel speed synchronization control (clutch engagement), increasing vehicle yaw moment and enabling drift entry and maintenance. Here, a control input is a clutch engagement torque.

However, only left and right wheel speed synchronization does not mean optimal drift performance. Control to make drift of the vehicle easier may be performed depending on a vehicle condition. Furthermore, in the case of a clutch-based system, torque distribution and torque vectoring may not be performed when not in a driving situation.

Depending on a vehicle type, yaw damping performance may be lacking in a transition situation where direction changes occur during drifting (with reference to FIG. 3), and this is because a motor torque compared to weight is insufficient and spinning of rear wheels may not be maintained even with the maximum torque.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a control method which may more easily secure optimal drift entry, maintenance, release, and transition performance regardless of driving and braking in vehicles provided with various existing drive and brake systems including an electric vehicle provided with a motor-based drive system, and may implement sufficient yaw damping performance even in a transition situation, which is a limitation in the existing vehicles.

The objects of the present disclosure are not limited to the above-mentioned objects, and other objects not mentioned herein will be clearly understood by a person of ordinary skill in the art to which the present disclosure pertains (referred to as “a person skilled in the art”) from the following description.

In one aspect, the present disclosure provides a method of controlling drift of a vehicle, including determining, by a controller, whether a current driving situation of the vehicle is a drift entry situation or a release situation based on vehicle driving information configured to indicate a current driving state of the vehicle, and generating a drift index configured to indicate a current degree of drift from a determination result, determining, by the controller, a target yaw moment for left and right speed control depending on a driving situation or a braking situation of the vehicle and target yaw moments for drift assistance control depending on a driver input and a vehicle state in the drift entry situation, based on the vehicle driving information, and generating and outputting, by the controller, a target torque of a motor configured to drive each wheel of the vehicle based on the determined target yaw moments.

In an exemplary embodiment of the present disclosure, the determining whether the current driving situation of the vehicle is the drift entry situation or the release situation may include determining a steering-based target yaw rate based on a steering angle and a vehicle speed among the vehicle driving information, determining a steering-based target yaw acceleration based on the determined steering-based target yaw rate, determining a vehicle yaw acceleration from a vehicle yaw rate detected by a sensor among the vehicle driving information, estimating a vehicle lateral slip angle based on the vehicle driving information, and obtaining a lateral slip angle change rate from the estimated vehicle lateral slip angle or obtaining the lateral slip angle change rate using vehicle dynamics information, determining a yaw acceleration error which is a difference between the steering-based target yaw acceleration and the vehicle yaw acceleration, and a yaw rate error which is a difference between the steering-based target yaw rate and the vehicle yaw rate, and determining whether the current driving situation of the vehicle is the drift entry situation based on the yaw acceleration error, the yaw rate error, and the lateral slip angle change rate.

In another exemplary embodiment of the present disclosure, in the determining whether the current driving situation of the vehicle is the drift entry situation, it may be determined that the current driving situation of the vehicle is the drift entry situation, when a condition in which an absolute value of the yaw acceleration error exceeds a predetermined yaw acceleration error threshold, a condition in which an absolute value of the lateral slip angle change rate exceeds a predetermined lateral slip angle change rate threshold and a product of the lateral slip angle change rate and a vehicle lateral acceleration detected by a sensor is 0 or less, and a condition in which an absolute value of the yaw rate error exceeds a predetermined yaw rate error threshold and a product of the yaw rate error and the vehicle lateral acceleration is 0 or less are all satisfied.

In yet another exemplary embodiment of the present disclosure, the method may further include determining a drift target yaw rate based on the vehicle yaw rate, and determining whether the current driving situation of the vehicle is the drift release situation based on the yaw rate error, the drift target yaw rate, the steering-based target yaw rate, and the vehicle yaw rate.

In yet another exemplary embodiment of the present disclosure, in the determining whether the current driving situation of the vehicle is the drift release situation, it may be determined that the current driving situation of the vehicle is the drift release situation, when a condition in which the absolute value of the yaw rate error is less than or equal to the predetermined yaw rate error threshold, a condition in which a product of the drift target yaw rate and the yaw rate is greater than or equal to a predetermined yaw rate product threshold, and a condition in which an absolute value of a difference between the steering-based target yaw rate and the drift target yaw rate is less than or equal to a predetermined yaw rate difference threshold are all satisfied.

In still yet another exemplary embodiment of the present disclosure, determining the target yaw moment for left and right speed control may include determining a target left and right wheel speed difference depending on the driving situation or braking situation of the vehicle based on wheel speeds of a left wheel and a right wheel, a vehicle speed, and a target internal wheel slip amount depending on a turning direction of the vehicle, determining a left and right wheel speed difference from the wheel speeds of the left wheel and the right wheel, and determining the turning direction of the vehicle from vertical forces of the left wheel and the right wheel or a longitudinal acceleration and a lateral acceleration of the vehicle, determining whether the left and right speed control is on or off and a left and right wheel speed difference error depending on the driving situation or braking situation of the vehicle based on the determined target left and right wheel speed difference, the determined left and right wheel speed difference, and the determined turning direction of the vehicle, and determining a target yaw moment configured to cause the left and right wheel speed difference to follow the target left and right wheel speed difference in an ON state of the left and right speed control.

In a further exemplary embodiment of the present disclosure, in determining the target left and right wheel speed difference, in case of the driving situation of the vehicle, the target left and right wheel speed difference may be determined as a value corresponding to a difference between an free wheel speed of the left wheel and an free wheel speed of the right wheel or the vehicle seed, and in case of the braking situation of the vehicle, the target left and right wheel speed difference may be determined as a value corresponding to a difference between a target internal wheel speed, determined from the target internal wheel slip amount depending on the turning direction of the vehicle among the left wheel and the right wheel and the vehicle speed, and an external wheel speed.

In another further exemplary embodiment of the present disclosure, in determining whether the left and right speed control is on or off and the left and right wheel speed difference error, whether the left and right speed control is on or off may be determined depending on the turning direction based on the target left and right wheel speed difference, the left and right wheel speed difference, a driver's requested torque, and a target internal wheel torque for torque vectoring control, and the left and right wheel speed difference error may be determined depending on the turning direction based on the target left and right wheel speed difference and the left and right wheel speed difference.

In yet another further exemplary embodiment of the present disclosure, in determining the target yaw moment for left and right speed control and the target yaw moments for drift assistance control, the drift assistance control depending on the driver input and the vehicle state in the drift entry situation may include acceleration assistance control and steering assistance control configured to assist the vehicle in drifting depending on the driver input and the generated drift index, and yaw damping assistance control configured to assist the vehicle in drifting depending on the vehicle speed and a vehicle yaw rate.

In yet another further exemplary embodiment of the present disclosure, in a process of determining a target yaw moment for the acceleration assistance control, the target yaw moment for the acceleration assistance control may be determined using a driver's requested torque determined based on the vehicle driving information, the drift index, a vehicle speed, vertical force of a left wheel, and vertical force of a right wheel, as inputs.

In still yet another further exemplary embodiment of the present disclosure, the process of determining the target yaw moment for the acceleration assistance control may include normalizing the driver's requested torque by determining a normalization ratio which is a ratio of a filtered driver's requested torque, obtained by filtering the driver's requested torque, to a maximum driver's requested torque, determining a driver's requested torque for the acceleration assistance control as a value obtained by multiplying the normalization ratio by the maximum driver's requested torque, determining a gain for the acceleration assistance control based on the vehicle speed, vertical force of the left wheel, and vertical force of the right wheel, and determining the target yaw moment for the acceleration assistance control based on the determined driver's requested torque for the acceleration assistance control, the determined gain for the acceleration assistance control, and the drift index.

In a still further exemplary embodiment of the present disclosure, in determining the gain for the acceleration assistance control, a vertical force ratio configured to indicate a rate of turn of the vehicle may be determined from the vertical force of the left wheel, the vertical force of the right wheel, and the vehicle speed, and the gain for the acceleration assistance control may be determined by multiplying a control gain by the determined vertical force ratio.

In a yet still further exemplary embodiment of the present disclosure, a process of determining a target yaw moment for the steering assistance control may include determining a drift target yaw rate based on the vehicle yaw rate detected, corrected, or estimated by a yaw rate sensor among the vehicle driving information, determining a yaw rate control error which is a difference between the determined drift target yaw rate and the detected, corrected, or estimated vehicle yaw rate, and determining a target yaw moment configured to cause the vehicle yaw rate to follow the drift target yaw rate based on the yaw rate error.

In another exemplary embodiment of the present disclosure, in a process of determining a target yaw for the yaw damping assistance control, the target yaw for the yaw damping assistance control may be determined using the vehicle speed, a vehicle yaw rate detected by a yaw rate sensor, and a vehicle yaw acceleration obtained from the vehicle yaw rate or a lateral slip angle change rate among the vehicle driving information, as inputs.

In yet another exemplary embodiment of the present disclosure, the process of determining the target yaw for the yaw damping assistance control may include determining a target yaw acceleration or a target lateral slip angle change rate which is a damping target corresponding to the vehicle speed, determining a yaw acceleration error or a lateral slip angle change rate error based on the target yaw acceleration and the vehicle yaw acceleration, or the target lateral slip angle change rate, and determining a target yaw moment configured to cause the vehicle yaw acceleration or the lateral slip angle change rate to follow the target yaw acceleration or the target lateral slip angle change rate based on the yaw acceleration error or the lateral slip angle change rate error.

In yet another exemplary embodiment of the present disclosure, the method may further include determining a target wheel torque for the yaw damping assistance control, and in determining the target wheel torque for the yaw damping assistance control, a target wheel torque of a left wheel and a target wheel torque of a right wheel for the yaw damping assistance control may be determined based on the vehicle yaw acceleration or the lateral slip angle change rate, the vehicle yaw rate, and the target yaw moment for the yaw damping assistance control.

In still yet another exemplary embodiment of the present disclosure, determining the target wheel torque for the yaw damping assistance control may include generating a transition index by adding a value obtained by multiplying a filtered value of the vehicle acceleration or the lateral slip angle change rate by a first gain and a value obtained by multiplying a value, obtained by the vehicle yaw rate by the vehicle yaw acceleration, by a second gain, determining a yaw damping driving force gain corresponding to the transition index, determining the target wheel torque from the target yaw moment, a half track width, and an effective dynamic radius of the wheels, determining a moment bias ratio based on the yaw damping driving force gain and the target wheel torque, and determining the target wheel torque of the left wheel and the target wheel torque of the right wheel for the yaw damping assistance control from the target wheel torque using the moment bias ratio to correct driving force of the vehicle and provide a yaw moment.

In a further exemplary embodiment of the present disclosure, a plurality of modes including a comfort mode and a sports mode configured to implement different degrees of drift at the same driver input in the acceleration assistance control and the steering assistance control may be set in the controller, and the controller may perform assistance control depending on a mode selected by a driver through an interface connected to the controller.

In another further exemplary embodiment of the present disclosure, the controller may be provided so that through the interface connected to the controller, the driver tunes a predetermined value for the acceleration assistance control and the steering assistance control or a control value for the driver input, or tunes set values for each of modes configured to implement different degrees of drift at the same driver input or control values for each of the modes at the driver input.

In yet another further exemplary embodiment of the present disclosure, the controller may perform yaw moment and wheel torque control of the vehicle using the vehicle driving information including driving force information of the vehicle in the left and right wheel speed control and in the acceleration assistance control and the steering assistance control among the drift assistance control.

In yet another further exemplary embodiment of the present disclosure, in generating and outputting the target torque of the motor, the controller may be configured to determine a target wheel torque of each wheel by distributing the determined target yaw moment into each wheel torque based on target driving force, and may be configured to determine a target torque of the motor for driving each wheel of the vehicle based on the target wheel torque.

In still yet another further exemplary embodiment of the present disclosure, when the vehicle is a rear-wheel drive vehicle, the controller, assuming that the target driving force is 0, may be configured to determine a target wheel torque of a left wheel and a target wheel torque of a right wheel among rear wheels using the target yaw moment, a half track width of the rear wheels which is a distance from a center of mass of the vehicle to each of the rear wheels, and an effective dynamic radius of wheels of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

Other aspects and exemplary embodiments of the present disclosure are discussed infra.

The above and other features of the present disclosure are discussed infra.

### BRIEF DESCRIPTION OF THE DRAWINGS

FIG. 1 is a diagram illustrating various drive system hardware configurations for electric vehicles to which the present disclosure is applicable;

FIG. 2 is a block diagram showing the configuration of an apparatus for performing a drift control process according to an exemplary embodiment of the present disclosure;

FIG. 3 is a diagram illustrating a FIG. 8 drift state of a vehicle to which the present disclosure is applied;

FIG. 4 is a diagram for explaining a process of determining a drift situation and determining a drift index in the drift control process according to an exemplary embodiment of the present disclosure;

FIG. 5 is a diagram for explaining a method of performing left and right speed control in drift control according to an exemplary embodiment of the present disclosure;

FIG. 6 is a diagram for explaining a method of performing acceleration assistance in drift control according to an exemplary embodiment of the present disclosure;

FIG. 7 is a diagram for explaining a method of performing steering assistance in drift control according to an exemplary embodiment of the present disclosure;

FIG. 8 is a diagram for explaining a yaw damping control method in drift control according to an exemplary embodiment of the present disclosure; and

FIG. 9 and FIG. 10 are diagrams for explaining a target yaw moment coordination and target wheel torque determination method in drift control according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, predetermined dimensions, orientations, locations, and shapes, will be determined in portion by the particularly intended application and use environment.

In the figures, reference numbers refer to the same or equivalent portions of the present disclosure throughout the several figures of the drawing.

### DETAILED DESCRIPTION

Hereinafter reference will be made in detail to various embodiments of the present disclosure, examples of which are illustrated in the accompanying drawings and described below. Specific structural or functional descriptions in embodiments of the present disclosure set forth in the description which follows will be exemplarily provided to describe the exemplary embodiments of the present disclosure, and the present disclosure may be embodied in many alternative forms. Furthermore, it will be understood that the present disclosure should not be construed as being limited to the exemplary embodiments set forth herein, and the exemplary embodiments of the present disclosure are provided only to completely include the present disclosure and cover modifications, equivalents or alternatives which come within the scope and technical range of the present disclosure.

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the present disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for describing various exemplary embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

The present disclosure relates to a method of controlling drift of a vehicle, and more specifically, to a torque vectoring control method for drift assistance in an electric vehicle provided with a motor-based drive system.

The present disclosure relates to a wheel torque control method which assists a vehicle in more easily entering, maintaining, releasing, and transitioning drift behavior, after determining a driver's intention based on a driver input, such as an accelerator pedal input or a steering input.

Here, a wheel torque refers to a torque which is generated by one of various hardware, such as a general motor, an in-wheel motor, a hydraulic brake, or an electronic mechanical brake (EMB), and is applied to a wheel.

First, definitions of symbols used in the present specification are set forth in Tables 1 to 4 below.

TABLE 1

| Symbol | Meaning |
|---|---|
| HW | Hardware |
| TV | Torque Vectoring |
| BLDC | Brushless Direct Current (Motor) |
| APS | Accelerator Pedal Sensor |
| ESC | Electronic Stability Control |
| bDRIFT | Drift ON/OFF (Entry/Release) Flag |
| DRIFTIndex | Index Expressing Degree of Drift |
| Th | Threshold |
| A_{y} | Lateral Acceleration |
| X* | Target of Signal X (For example, V_{whl}*: Target wheel speed) |
| e_{□} | Error (Difference) of Signal X |
| e_{V}_{_{whl}} | Left and Right Wheel Speed Difference (Error) |
| V_{□} | Vehicle Speed |
| $\frac{{V}_{whlL}^{*}}{R}$ | Target Left/Right Wheel Speed (Each of Target Left and Right Wheel Speeds) |
| e_{V}_{_{whl}}* | Target Left and Right Wheel Speed Difference |

TABLE 2

| Symbol | Meaning |
|---|---|
| Free Wheel Speed | Speed of Wheel Position (Speed of Wheel Position |
| | in Vehicle other than Wheel_{rotation speed}) |
| F_{□□}, F_{□□} | Vertical Force of Wheel (Left, Right) |
| Δ | Target Offset Amount |
| τ_{□□□} | Driver's Requested Torque |
| τ_{Cmd, L}, τ_{Cmd, R} | Target Left and Right wheel Torques (Torque |
| | Vectoring Final Control Commands) |
| LRSC | Left and Right Speed Control |
| bLRSCDrv/ | Left and Right Speed Control ON/OFF flag in |
| bLRSCBrk | Driving/Braking Situation |
| Err | Error |
| K_{□}, K_{□}, K_{□} | PID Control Gains (Map-based Configuration for |
| | Each Control or Driving Situation) |

TABLE 3

| Symbol | Meaning |
|---|---|
| s | Laplace Variable (Variable for Expressing Transfer |
| | Function) |
| M_{□} | Yaw Moment (Vehicle) |
| η_{τ□□□} | Driver's Requested Torque Ratio (Ratio of Driver's |
| | Requested torque to Maximum Torque) |
| τ_{Drv, Filtered} | Driver's Requested Torque Filtering Result Signal |
| τ_{Drv, MAX} | Driver's Requested Torque Maximum Value (Vehicle |
| | Spec.) |
| τ_{Drv, APSAssist} | Driver's Requested Torque Amount Correction Value for |
| | Acceleration assistance Control |
| K | Control Gain |
| K_{Drv, APSAssist} | Acceleration assistance Control Gain |
| η_{ΔF}_{_{z}} | Rate of Turn (Degree of Turn) of Vehicle based on Left and |
| | Right Wheel Vertical Forces |
| APSAssist | Acceleration assistance Control |
| LPF | Low-pass filter |
| ω | Vehicle Yaw Rate |
| β | Lateral Slip Angle |
| e_{\dot{ω}} or e_{\dot{β}} | Yaw Acceleration Error or Lateral Slip Angle Change Rate |
| | Error |
| r_{□□□} | Effective Dynamic Radius |

TABLE 4

| Symbol | Meaning |
|---|---|
| T | Half Track Width |
| Transition | Index for Expressing Yaw motion Transition (Excessive |
| IDX | Yaw Motion Occurrence) Situation |
| K_{\dot{β}} | Lateral Slip Angle Change Rate (or Yaw Acceleration) |
| | Component Gain |
| K_{\dot{β}ω} | ‘Lateral Slip Angle Change Rate (or Yaw Acceleration) × |
| | Yaw Rate’ Component Gain |
| K_{F□} | Driving Force (Fₓ) Ratio Gain Given When Generating |
| | Yaw Moment for Yaw Damping |
| MBR | Wheel Torque Distribution Ratio Considering Driving |
| (Moment | Force (Fₓ) Given When Generating Yaw Moment for |
| Bias Ratio) | Yaw Damping |
| OS | Oversteer |
| US | Understeer |

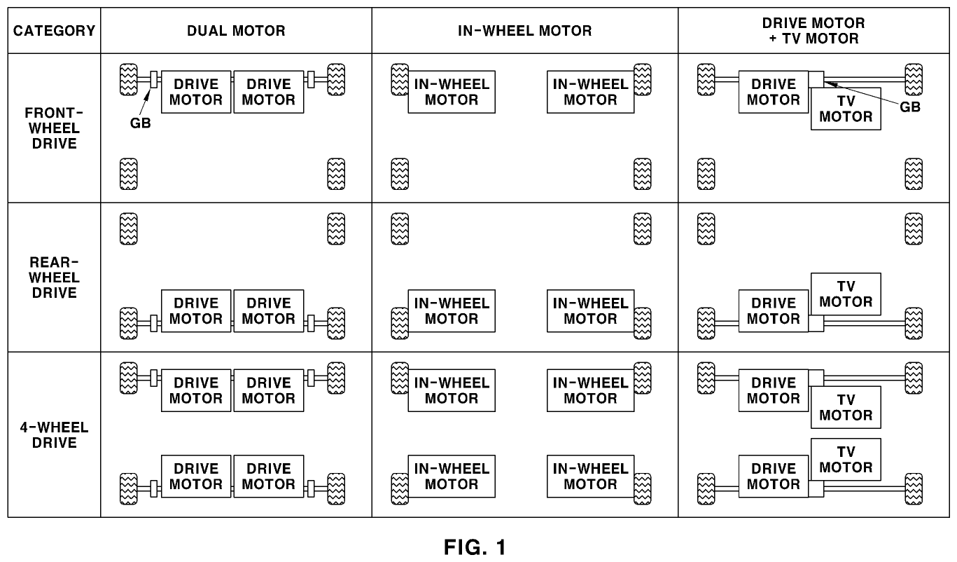

FIG. 1 is a diagram illustrating various drive system hardware configurations for electric vehicles to which the present disclosure is applicable, and the present disclosure may be applied to a vehicle in which a drive motor is connected to each of left and right wheels, a vehicle in which an in-wheel motor is connected to left and right wheels, and a vehicle in which a drive motor and a torque vectoring (referred to hereinafter as a “TV motor”) are connected to left and right wheels. In FIG. 1, GB represents a reducer (a gear box).

Furthermore, the present disclosure relates to a torque vectoring-based drift control method of a motor-driven vehicle. The platform setups (HW configurations) of general motor-based vehicles may be summarized, as shown in FIG. 1, and the torque vectoring-based drift control method according to an exemplary embodiment of the present disclosure may be applied to all platform setups shown in FIG. 1 and arbitrary motor torque vectoring platforms (including any arbitrary number of left and right wheel sets) derived therefrom.

A drive motor generally applies torque to each wheel through the reducer (the gearbox, GB). Here, the drive motor may apply a torque to one wheel or wheels of one axis (i.e., a left wheel and a right wheel), and when the drive motor applies a torque to the wheels of one axis, the torque is generally distributed into left and right torques through a differential gear.

An in-wheel motor vehicle may adopt a method of mounting a tire directly on the rotor of a motor, such as a brushless direct current (BLDC) motor. A TV motor transmits a wheel torque through a gearbox (GB) including a combination of planetary gears and reverse gears to provide yaw moments due to torques in the opposite directions to a left wheel and a right wheel.

A motor torque may be determined in various ways so that the wheel torque generated by the control method according to an exemplary embodiment of the present disclosure may be applied to suit various HW setups.

In addition to the illustrated hardware configurations, the present disclosure may be applied to various other configurations, such as combinations of drive motors, which are generally used, and eLSDs, twin clutches, and the like, in consideration of hardware characteristics.

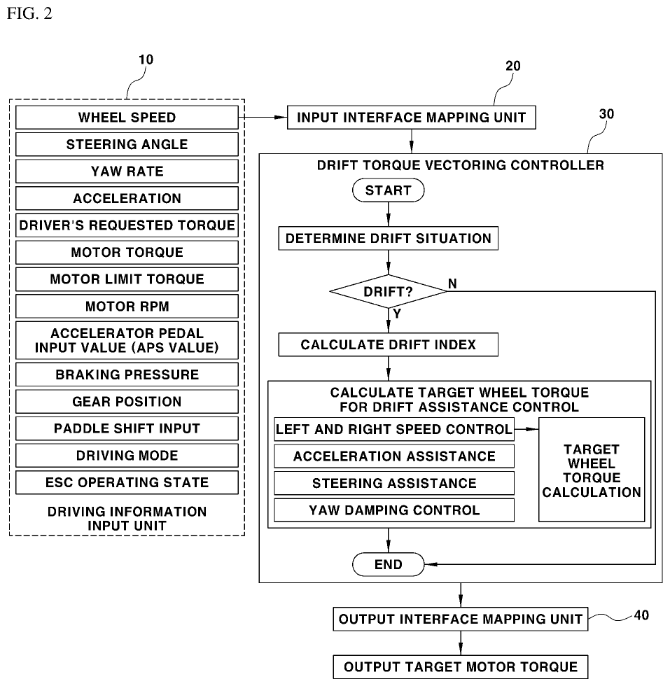

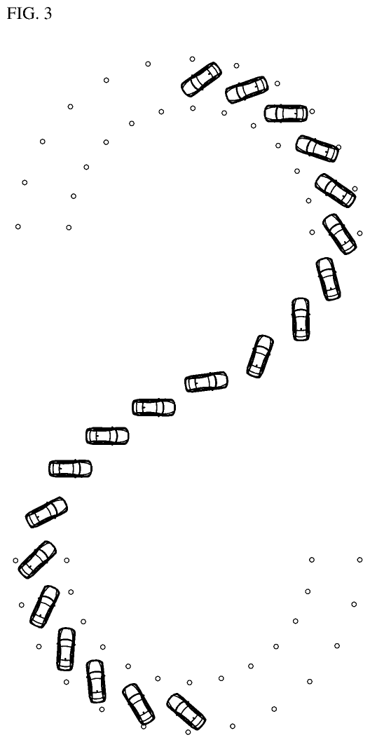

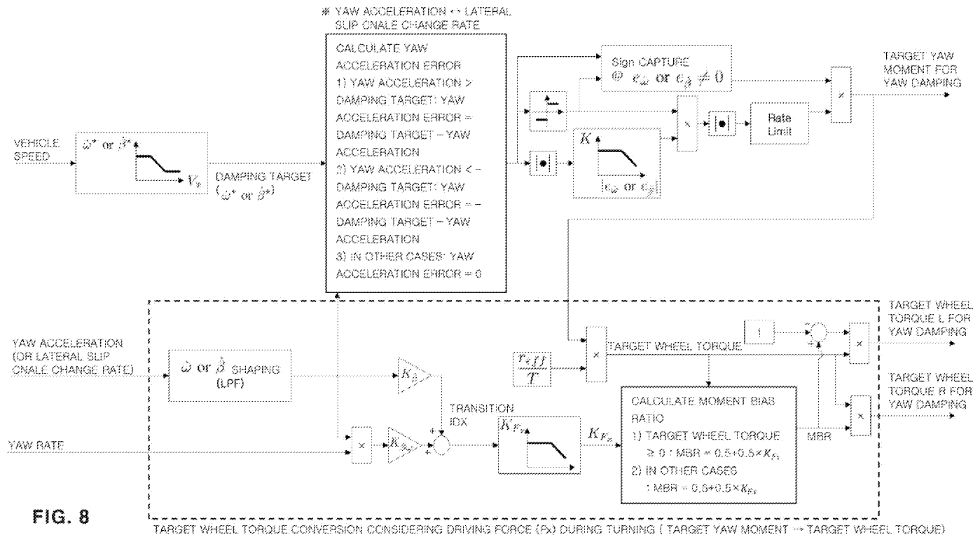

FIG. 2 is a block diagram showing the configuration of an apparatus for performing a drift control process according to an exemplary embodiment of the present disclosure. Furthermore, FIG. 3 is a diagram illustrating a FIG. 8 drift state of a vehicle to which the present disclosure is applied, showing that drift transition in the opposite direction of turning of the vehicle occurs in the middle of drift driving.

In the following description, transition means drift transition in which the driving situation of the vehicle is changed in the opposite direction of turning of the vehicle in the middle of the FIG. 8 drift driving, as shown in FIG. 3.

As shown in these figures, the apparatus for performing the drift control process according to an exemplary embodiment of the present disclosure includes a driving information input unit 10, an input interface mapping unit 20, a drift torque vectoring controller 30, and an output interface mapping unit 40.

Here, except for the driving information input unit 10 which is an input element, the input interface mapping unit 20, the drift torque vectoring controller 30, and the output interface mapping unit 40 may be said to be one control element, i.e., a control element, which is configured to perform torque vectoring control and drift control.

This control element itself may be a separate controller, or may be a portion of a controller, and in an exemplary embodiment of the present disclosure, the control element, which is configured to perform torque vectoring control and drift control, and elements illustrated as parts of the driving information input unit 10 in FIG. 2, i.e., elements, through which a driver's requested torque, a motor torque, and a motor limit torque are input and provided, may all be collectively referred to as one controller.

The driving information input unit 10 detects, provides and/or inputs vehicle driving information, which is information indicating a vehicle driving state, and includes sensors, switches, and controllers (control elements) which detect or input the vehicle driving information.

Here, the vehicle driving information includes driver input information and vehicle state information, and specifically, may include a wheel speed, which is the rotation speed of each wheel, a steering angle, which is a driver's steering input value, a yaw rate and acceleration of the vehicle, a motor RPM, an accelerator pedal input value (accelerator pedal sensor (APS) value), a braking pressure (hydraulic pressure), driver's requested torque, a motor torque (command), a motor limit torque, a current gear position, paddle shift input information, a driving mode, and electronic stability control (ESC) operation state information. Here, the ESC operation state information may be information indicating an ESC OFF state.

In the apparatus for performing the drift control process according to an exemplary embodiment of the present disclosure, the drift vectoring controller 30 is configured to perform torque vectoring control according to signals from the driving information input unit 10 including various sensors, switches and controllers mounted on the vehicle, and transmits a target torque of each motor and a target wheel torque of each wheel as outputs.

Among the vehicle driving information, the motor torque, the motor limit torque and the motor revolutions per minute (rpm) may be values corresponding to each motor for each of the various platform setups illustrated in FIG. 1, and the driver's requested torque may be a driver's requested torque for the entire vehicle, or may be a required torque for each motor obtained from a driver input value. These vary depending on a control level and vehicle specifications to which the present disclosure is applied.

Among the elements of FIG. 2, the input interface mapping unit 20 converts the torques (commands), limit torques, and RPMs of all motors depending on each driving method illustrated in FIG. 1 into a torque, a limit torque, and a wheel speed for each wheel of the vehicle.

Furthermore, the output interface mapping unit 40 converts the target torque, limit torque, and wheel speed for each wheel output from the drift torque vectoring controller 30 into target torques, limit torques, and RPMs for all motors depending on each driving method illustrated in FIG. 1.

When a driver performs steering input, acceleration input, and braking input to drive the vehicle in various situations, vehicle behavior is changed thereby.

When the drift torque vectoring controller 30 receives signals indicating the vehicle driving information, such as driver input signals, from the driving information unit 10, processes the received signals, and outputs the processed signals, to allow the present process to be universally applied to the various hardware configurations shown in FIG. 1, the input interface mapping unit 20 and the output interface mapping unit 40 perform input and output interface mapping to enable the present process to be controlled from the point of view of the vehicle and each wheel, as described above.

Here, the drift torque vectoring controller 30 is configured to determine a driver's drift intention and a drift driving situation based on physical values from the point of view of the vehicle and determined sensor correction values, and is configured to perform torque vectoring control for drift.

The drift torque vectoring controller 30 is configured to perform torque vectoring control to assist the driver in more easily entering, maintaining, and releasing drift.

To the present end, the drift torque vectoring controller 30 is configured to perform drift situation determination and index determination. First, the drift torque vectoring controller 30 is configured to determine whether the current driving situation of the vehicle is a drift situation based on information indicating the current vehicle driving state, such as the current driver intention and driving situation, that is, the vehicle driving information input by the driving information input unit 10.

Furthermore, the drift torque vectoring controller 30 is configured to determine an index based on a drift ON/OFF flag, and in the drift situation, the drift index is determined as a value other than 0, and accordingly, drift control and torque vectoring control (torque vectoring-based drift assistance control) to assist in easily entering, maintaining, releasing, and transitioning drift are performed.

Furthermore, the drift torque vectoring controller 30 is configured to perform left and right speed control based on the determined drift index, and at the instant time, is configured to perform drift control based on left and right wheel speed synchronization that simulates general clutch-based torque vectoring. Accordingly, the same drift linearity as a general clutch-based limited slip differential (LSD) is implemented and secure (virtual LSD implementation).

Furthermore, the drift torque vectoring controller 30 is configured to perform acceleration assistance control in which a target yaw moment depending on accelerating, which is one of driver input values (driver's driving operation values), is generated and provided to the vehicle to correct driver errors in acceleration and to smooth vehicle behavior in response to driver's acceleration to enable drifting even with softer acceleration.

In the present specification, acceleration refers to driver input (acceleration input) that causes the vehicle to accelerate, and may be the opposite of braking, which is driver input (braking input) that causes the vehicle to decelerate.

Furthermore, the drift torque vectoring controller 30 assists steering input, which is another input from the driver, in the drift situation, performs steering assistance that smooths the yaw motion of the vehicle even in a drift maintenance situation, and performs steering assistance control to correct driver errors in countersteer and to enable drifting with softer countersteer.

Furthermore, the drift torque vectoring controller 30 is configured to perform yaw damping control to limit a yaw acceleration (lateral slip angle change rate) so that the driver may easily maintain drifting even in a transition situation in the opposite direction of turning of the vehicle during drifting, as shown in FIG. 3.

The drift torque vectoring controller 30 is configured to perform additional yaw damping control to ensure stability in a drift transition section and reduces an excessive yaw acceleration (lateral slip angle change rate), increasing ease in entering, maintaining, releasing, and transitioning drifting.

When the drift torque vectoring controller 30 outputs final target torques for the vehicle and the wheels based on the target yaw moment determined through the above control process, the output interface mapping unit 40 converts the target torques for the vehicle and the wheels into a target torque of each motor for each hardware (HW) setup, and finally outputs and is configured to determine the target torque of each motor.

Hereinafter, such a control process will be described with reference to the drawings.

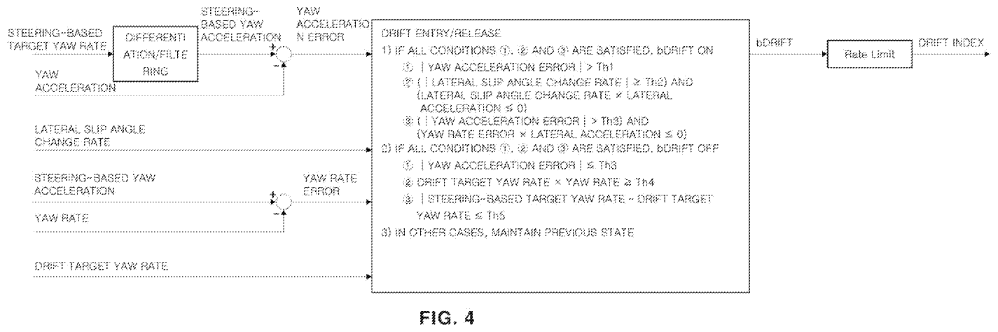

FIG. 4 is a diagram for explaining a process of determining the drift situation and determining the drift index in the drift control process according to an exemplary embodiment of the present disclosure.

First, the drift torque vectoring controller 30 is configured to determine drift entry or release by processing the vehicle driving information input by the driving information input unit 10, and as a result of the determination, generates flag bDRIFT indicating drift entry DRIFT ON or drift release DRIFT OFF.

Here, the drift torque vectoring controller 30 is configured to determine and utilizes a steering-based target yaw rate, which is currently desired by the driver, based on real-time vehicle driving information including a current steering angle and a current vehicle speed Vₓ input by the driving information input unit 10.

Here, the steering angle is information obtained from a signal from a steering angle sensor (SAS) of the driving information input unit 10, and the vehicle speed Vₓ is information obtained and estimated from a signal from a wheel speed sensor or a vehicle speed sensor of the driving information input unit 10.

Furthermore, a steering-based target yaw acceleration is determined by differentiating and filtering the steering-based target yaw rate. Furthermore, a vehicle yaw acceleration \dot{ω} is obtained by differentiating a signal from a yaw rate sensor, which detects a vehicle yaw rate ω, of the driving information input unit 10, and a lateral slip angle change rate \dot{β} is obtained. Here, the lateral slip angle change rate \dot{β} may be determined from a lateral slip angle β estimated based on the vehicle driving information using a known method, or may be determined directly using vehicle dynamics separately from estimation of the lateral slip angle β.

Furthermore, a target yaw rate for drifting ω_{Drift}* is used to determine drift entry and release, and because the goal of the drift situation of the vehicle is ultimately to generate and maintain the currently maintained yaw rate state, the drift target yaw rate ω_{□□□□□}* is determined based on the current vehicle yaw rate ω information.

That is, for more comfortable drift maintenance performance, the drift target yaw rate ω_{□□□□□}* is determined by appropriately filtering the current vehicle yaw rate ω depending on the situation, and is determined by performing shaping and transition depending on the situation to reduce phase delay due to a low-pass filter (LPF) for filtering when FIG. 8 drifting, as shown in FIG. 3.

The process of determining the drift target yaw rate ω_{□□□□□}* will be explained in more detail later when steering assistance will be explained, and steering assistance is performed by determining a target yaw rate error in the drift situation based on the drift target yaw rate ω_{□□□□□}*.

Furthermore, as shown in FIG. 4, the drift torque vectoring controller 30 is configured to determine a yaw acceleration error e_{\dot{ω}}, which is a difference between the steering-based target yaw acceleration and the vehicle yaw acceleration \dot{ω} obtained by differentiating the signal from the yaw rate sensor. Furthermore, the drift torque vectoring controller 30 is configured to determine a yaw rate error e_{□}, which is a difference between the steering-based target yaw rate and the vehicle yaw rate ω detected by the yaw rate sensor.

Ultimately, the drift torque vectoring controller 30 is configured to determine drift entry and release using the yaw acceleration error e_{\dot{ω}}, which is the difference between the steering-based target yaw acceleration and the vehicle yaw acceleration \dot{ω} the lateral slip angle change rate \dot{β} determined from the lateral slip angle β of the vehicle or determined from vehicle dynamics, the yaw rate error e_{□}, which is the difference between the steering-based target yaw rate and the vehicle yaw rate ω, and the drift target yaw rate ω_{□□□□□}* determined based on the detected vehicle yaw rate ω.

In determining drift entry and release, in the case of a conventional drift determination method which is commonly used, the drift torque vectoring controller 30 is configured to determine drift entry when the directions of the steering angle and the vehicle yaw rate ω or the steering angle and a vehicle lateral acceleration A_{y} are opposite (i.e., when the product of the two values is negative), and in the present situation, determination of drift entry is delayed.

Therefore, even though it is the actual moment of drift entry, i.e., even at the moment when countersteer starts, the present situation may be determined as not drifting, and consequently, entry-related control may be delayed, resulting in performance deterioration.

Accordingly, in an exemplary embodiment of the present disclosure, the drift torque vectoring controller 30 is configured to determine that the vehicle enters drift (DRIFT ON) and generates a drift entry flag (bDRIFT ON), when all of a condition in which the absolute value of the yaw acceleration error e_{\dot{ω}} exceeds a predetermined yaw acceleration error threshold Th1, a condition in which the absolute value of the lateral slip angle change rate \dot{β} exceeds a predetermined lateral slip angle change rate threshold Th2 and the product of the lateral slip angle change rate \dot{β} and the vehicle lateral acceleration A_{y} is 0 or less (0 or a negative number), and a condition in which the absolute value of the yaw rate error e_{□} exceeds a predetermined yaw rate error threshold Th3 and the product of the yaw rate error e_{□} and the vehicle lateral acceleration A_{y} is 0 or less (0 or a negative number) are satisfied.

On the other hand, the drift torque vectoring controller 30 is configured to determine that the vehicle releases drift (DRIFT OFF) and generates a drift release flag (bDRIFT OFF), when all of a condition in which the absolute value of the yaw rate error e_{□} is less than or equal to the predetermined yaw rate error threshold Th3, a condition in which the product of the drift target yaw rate ω_{□□□□□}* and the yaw rate is greater than or equal to a predetermined yaw rate product threshold Th4, and a condition in which the absolute value of a difference between the steering-based target yaw rate and the drift target yaw rate ω_{□□□□□}* is less than or equal to a predetermined yaw rate difference threshold Th5 are satisfied.

When all of the drift entry determination conditions or all of the drift release determination conditions are not satisfied, it is determined that the previous drift state is maintained. The respective thresholds may be tuned values, and are set as predetermined values in the drift torque vectoring controller 30.

As described above, in an exemplary embodiment of the present disclosure, when a difference between a driver's steering intention and a current vehicle movement direction increases (i.e., when the yaw acceleration error e_{\dot{ω}} and the yaw rate error e_{□} are above the thresholds (tuned values)), when a difference between the actual trajectory and the posture (yaw angle) of the vehicle increases (i.e., when the lateral slip angle change rate \dot{β} is above the threshold), and when the product of the lateral slip angle change rate \dot{β} and the vehicle lateral acceleration A_{y} is a negative number (in the direction of oversteer generation) in consideration of the turning direction of the vehicle, it is determined that the vehicle enters drift.

On the other hand, when the vehicle gets out of the drift situation a lot (when the difference between the steering-based target yaw rate and the drift target yaw rate ω_{□□□□□}* is less than or equal to the threshold) as the steering intention and vehicle behavior become consistent (as the yaw rate error e_{□} is less than or equal to the threshold), and when the drift direction is the same as the current turning direction of the vehicle (when the product of the drift target yaw rate ω_{□□□□□}* and the vehicle yaw rate is greater than or equal to the threshold), it is determined that the vehicle releases drift. In other cases, the vehicle maintains the previous state.

Consequently, the drift on flag bDRIFT ON or the drift off flag bDRIFT OFF is generated depending on the above determination result, and when the slope of a corresponding value are limited to an appropriate slope (rate) in each of the increasing direction and the decreasing direction (rate limit), the drift index DRIFTIndex may be determined.

In an exemplary embodiment of the present disclosure, the case, in which the drift entry determination conditions are satisfied and thus the current driving situation of the vehicle is determined as a drift entry situation, is defined as a drift situation-on state, i.e., a drift-on state (DRIFT ON), and the case, in which the drift release determination conditions are satisfied and thus the current driving situation of the vehicle is determined as a drift release situation, is defined as a drift situation-off state, i.e., a drift-off state (DRIFT OFF).

The variable value of the drift flag may be said to be a Boolean value, i.e., a value of 0 or 1, and a drift mode transition rate is defined by converting the variable value of the drift flag into a continuous real number variable between 0 and 1 (a single or double data type), and then performing rate limit. That is, by converting the value of 0 or 1 indicating “entry/release”, mathematical expressions of “smooth entry” (transition from 0 to 1 at a limited slope through rate limit) and “smooth release” (transition from 1 to 0 at a limited slope through rate limit) may be obtained.

The value between 0 and 1 with such a limited slope is defined as the drift index DRIFTIndex and used as a drift mode control value, and all transition slopes when entering and releasing the drift mode to determine each yaw moment may be determined by tuning the present value.

Ease of entry to and release from drift may be determined by control in the drift transition process, and therefore, control in the transition situation is necessary in addition to control in the drift-on and drift-off situations in which drift is completely determined, and smooth transition between the two situations is important.

Therefore, smooth transition and yaw moment shaping are required between two controls, i.e., control in the drift-on situation and control in the drift-off situation, and because they relate to a degree of occurrence of drift or release of drift, in an exemplary embodiment of the present disclosure, a degree of transition is defined by assigning a slope to the drift index which is a drift flag value.

The drift index DRIFTIndex is a type of gain, and in an exemplary embodiment of the present disclosure, is multiplied by each yaw moment component to smoothly transition the control, securing drift entry and release performance.

Accordingly, in an exemplary embodiment of the present disclosure, when values, such as the difference between the steering-based target yaw rate and the yaw rate, the difference between the drift target yaw rate and the steering-based target yaw rate, and the lateral slip angle change rate \dot{β}, are directly determined, a driver's countersteer situation for drift control may be more rapidly determined.

Therefore, through the index determined based on the rapidly determined drift entry or release situation, drift entry control or drift release control in the drift situation may be more rapidly and smoothly performed, allowing the driver to feel more comfortable drift entry and causing control transition to be more precisely performed even when escaping from turning.

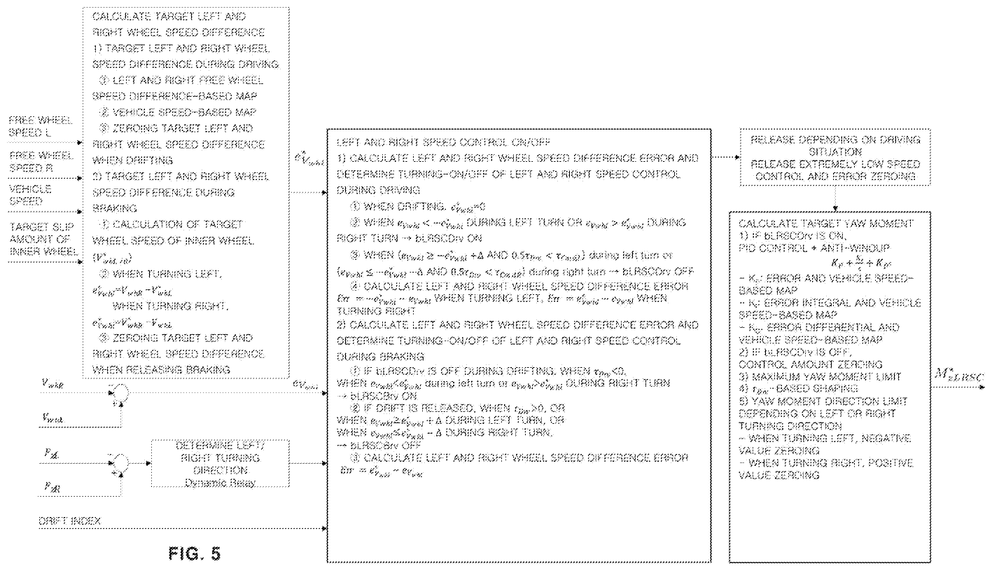

Next, FIG. 5 is a diagram for explaining a method of performing left and right speed control (LRSC) during drift control according to an exemplary embodiment of the present disclosure.

In general, a reference vehicle speed is required to specify wheel slip at one wheel, and as is known, a wheel slip ratio X may be obtained as a value of “(wheel speed−vehicle speed)/wheel speed”.

However, this is true in terms of one wheel having one mass, but more strictly, the vehicle speed and a speed at each wheel position are different. The vehicle speed may refer to the speed of the center of gravity (CG) of the vehicle.

On the other hand, the speed of each wheel position in the vehicle is a value obtained by adding the relative speed of the wheel position relative to the center of gravity CG (i.e., the product of a distance to the wheel position and the yaw rate) to the vehicle speed, and the wheel speeds of four wheels of the vehicle may vary depending on the driving situation.

In FIG. 5, the free wheel speed of the left wheel (free wheel speed L) and the free wheel speed of the right wheel (free wheel speed R) are a wheel speed at the left wheel position and a wheel speed at the right wheel position, as described above, and the free wheel speed of each wheel may be expressed as the product of the distance from the center of gravity CG to the wheel position depending on vehicle specifications (a distance in the longitudinal or lateral direction of the vehicle) and the yaw rate of the vehicle.

In the case of existing clutch-based torque vectoring, a torque is transmitted by engaging a clutch to synchronize the left and right wheel speeds to ensure performance. In an exemplary embodiment of the present disclosure, left and right wheel speed synchronization control is implemented, and basic drift performance is secured through the present left and right wheel speed synchronization control.

For the present purpose, a target left and right wheel speed difference e_{Vwhl}* is first determined. Referring to FIG. 5, the free wheel speed L, the free wheel speed R, the vehicle speed, and a target slip amount of an internal wheel are used as input information to determine the target left and right wheel speed difference e_{Vwhl}*.

While driving, the target left and right wheel speed difference e_{Vwhl}* is determined using a map based on a difference between the free wheel speed L and the free wheel speed R, and the vehicle speed, and in the drift situation, synchronization of the left and right wheels is achieved by zeroing the target left and right wheel speed difference e_{Vwhl}* (resetting the target left and right wheel speed difference e_{Vwhl} to 0).

During braking, appropriate oversteer (OS) may be generated regardless of whether an anti-brake system (ABS) is activated, and therefore, only internal wheel slip is controlled, not external wheel slip. For the present purpose, the target left and right wheel speed difference e_{Vwhl}* in a braking situation is determined based on the determination result of a target internal wheel speed V_{whlL}* or V_{whlR}* depending on the turning direction of the vehicle. The target internal wheel speed V_{whlL}* or V_{whlR}* may be obtained from the vehicle speed, which is input information, and a target slip amount of the internal wheel.

When a target slip amount is determined, a target wheel speed may be determined using the definition of the slip amount “(wheel speed−vehicle speed)/wheel speed”. Here, the target slip amount may be tuned for drift driving emotion.

After determining the target internal wheel speed V_{whlL}* or V_{whlR}* depending on the turning direction, a difference between the target internal wheel speed V_{whlL}* or V_{whlR}* depending on the turning direction and the external wheel speed V_{whlR} or V_{whlL} is determined as the target left and right wheel speed difference e_{Vwhl}*. At the instant time, except for determining the target internal wheel speed, the target left and right wheel speed difference e_{Vwhl}* during braking may be determined differently depending on the situation, that is, a target internal and external wheel speed difference during braking may be directly determined.

Here, the target left and right wheel speed difference e_{Vwhl}* is also used as an entry condition for left and right speed control (LRSC), the target left and right wheel speed difference e_{Vwhl}* includes a positive (+) value regardless of the turning direction while driving, and the sign of the target left and right wheel speed difference e_{Vwhl}* is changed in consideration of the turning direction, i.e., a left or right turning direction, in the braking situation. The positive (+) value of the target left and right wheel speed difference e_{Vwhl}* regardless of the turning direction while driving is to allow a left and right wheel speed difference error which may occur when turning left or right.

The internal wheel and the external wheel are determined depending on the turning direction during turning of the vehicle, and in the following description, the internal wheel refers to a vehicle wheel relatively closer to the center of turning of the vehicle among the left and right wheels, and the external wheel refers to a vehicle wheel relatively farther from the center of turning of the vehicle among the left and right wheels. In the present way, in a vehicle turning situation, the left and right wheels may be divided into the internal and external wheels, and in the case of a left turn, the left wheel may become the internal wheel and the right wheel may become the external wheel.

In a normal turning situation, the internal wheel often spins, and in the case of a rapid braking situation, the internal wheel among the rear wheels of the vehicle spins and thus results in large oversteer (OS), causing very extreme behavior from the driver's perspective.

To control oversteer to generate a smoother and more appropriate oversteer behavior, the spin of the internal wheel is limited (or controlled) to generate appropriate oversteer which is not uncomfortable for the driver in a braking drift entry situation, and for the present purpose, the target internal wheel speed is determined and used. Here, the target internal wheel speed is determined based on the target slip amount of the internal wheel by the above-described method.

Because the target left and right wheel speed difference e_{Vwhl}* is determined as the difference between the target internal wheel speed V_{whlL}* or V_{whlR}* and the external wheel speed V_{whlR} or V_{whlL}, and in the case of a left turn, the left wheel is the internal wheel depending on the turning direction and the right wheel is the external wheel, as shown in FIG. 5, a value obtained by subtracting the target left wheel speed V_{whlL}* from the right wheel speed V_{whlR} is determined as the target left and right wheel speed difference e_{Vwhl}* when turning left (e_{Vwhl}*=V_{whlR}−V_{whlL}*).

On the other hand, since, in the case of a right turn, the right wheel is the internal wheel depending on the turning direction and the left wheel is the external wheel, a value obtained by subtracting the left wheel speed V_{whlL} from the target right wheel speed V_{whlR}* is determined as the target left and right wheel speed difference e_{Vwhl}* when turning right (e_{Vwhl}*=V_{whlR}*−V_{whlL}). Here, the left wheel speed and the right wheel speed are speeds detected or estimated by wheel speed sensors.

When braking is released, the target left and right wheel speed difference e_{Vwhl}* is zeroed (is reset to 0) to achieve synchronization of the left and right wheel speeds.

When the target left and right wheel speed difference e_{Vwhl}* is determined, a left and right wheel speed difference e_{Vwhl}, which is a difference between the left wheel speed V_{whlL} and the right wheel speed V_{whlR}, and the left or right turning direction is determined based on the vertical force F_{□□} of the left wheel and the vertical force F_{□□} of the right wheel.

Furthermore, when the left or right turning direction is determined, whether left and right speed control is on or off is determined depending on the situation using the target left and right wheel speed difference e_{Vwhl}*, the turning direction information, the drift index DRFITIndex determined as described above, and the left and right wheel speed difference e_{Vwhl}.

At the present time, turning-on or turning-off of left and right speed control is determined with reference to a target left and right wheel speed control situation depending on the left or right turning direction.

First, in the case of a driving situation, after obtaining the target left and right wheel speed difference e_{Vwhl}* for drifting, whether left and right speed control is on or off is determined by comparing the left and right wheel speed difference e_{Vwhl} with the target left and right wheel speed difference e_{Vwhl}*, and an on or off flag bLRSCDrv ON or bLRSCDrv OFF is generated.

At the present time, taking a left turn as an exemplary embodiment of the present disclosure, in a normal turning situation, the right wheel speed is greater than the left wheel speed, and thus, the target left and right wheel speed difference e_{Vwhl}* is also a positive (+) value. In a drift entry situation, to prevent the left wheel from spinning alone due to increase in the left wheel speed, which is the internal wheel speed, the left and right wheel speed difference e_{Vwhl} (the right wheel speed−the left wheel speed) is a negative (−) value, and thus, the positive target left and right wheel speed difference e_{Vwhl}* is changed to a negative (−) value, and when the left and right wheel speed difference e_{Vwhl} is less than the negative value of the target left and right wheel speed difference e_{Vwhl}*, the vehicle enters left and right speed control.

This may be tuned depending on the situation. When a wheel speed difference condition opposite to the wheel speed difference condition in the case in which left and right speed control is on occurs depending on the turning direction and there is no driver's intention to drive, i.e., no driver's intention to drift (when a driver's requested wheel torque is less than an internal wheel torque) with some hysteresis, it is determined that left and right speed control is off and thus the off flag bLRSCDrv OFF is generated.

In determining whether left and right speed control is on or off while driving, in a drift situation, the target left and right wheel speed difference e_{Vwhl}* is zeroed (reset to 0) (e_{Vwhl}*=0), and when e_{Vwhl}<−e_{Vwhl}* during a left turn or e_{Vwhl}>e_{Vwhl}* during a right turn, it is determined that left and right wheel speed control is on and thus the on flag bLRSCDrv ON is generated.

Furthermore, when e_{Vwhl}≥−e_{Vwhl}*+Δ and 0.5τ_{□□□}<τ_{Cmd,L} during a left turn or e_{Vwhl}≤−e_{Vwhl}*+Δ and 0.5τ_{□□□}<τ_{Cmd,R} during a right turn, it is determined that left and right wheel speed control is off and thus the off flag bLRSCDrv OFF is generated.

Here, τ_{□□□} represents a driver's requested torque, Δ represents a target offset amount, τ_{Cmd,L} represents the target wheel torque (command value) of the left wheel (inner wheel during a left turn) as a final control command of torque vectoring, and τ_{Cmd,R} represents the target wheel torque (command value) of the right wheel (inner wheel during a right turn) as a final control command of torque vectoring.

At the present time, the above two final control commands are final commands in drift assistance control, and if there is separate control logic, for example, torque-speed (T-N) curve limit control or failsafe control, performed after the present control logic, the two final control commands mean final control commands in torque vectoring control logic including all of these control logics, and may actually be values immediately before the final control commands.

Furthermore, a left and right wheel speed difference error Err while driving is determined depending on a left or right turning situation. Since, in determining the target left and right wheel speed difference, the sign of the target left and right wheel speed difference is not considered in the driving situation, the left and right wheel speed difference error Err is determined in consideration of the sign of the target left and right wheel speed difference. If the sign of the target left and right wheel speed difference is considered even in the driving situation in determining the target left and right wheel speed difference, there is no need to consider the sign of the target left and right wheel speed difference in determining a final left and right wheel speed difference error Err.

The left and right wheel speed difference error Err while driving is determined as a difference between the target left and right wheel speed difference e_{Vwhl}* and the left and right wheel speed difference e_{Vwhl}, and the left and right wheel speed difference error Err is determined as an equation “Err=e_{Vwhl}*−e_{Vwhl}” in the case of a left turn, and is determined as an equation “Err=e_{VWhl}*−e_{Vwhl}” in the case of a right turn.

In a braking situation, whether left and right speed control is on or off in the braking situation is determined by determining whether it is not a drift driving situation and whether the driver's requested torque τ_{□□□} is a negative value, and comparing the left and right wheel speed difference e_{Vwhl} with the target left and right wheel speed difference e_{Vwhl}*, and the on or off flag bLRSCDrv ON or bLRSCDrv OFF is generated depending on a result of the determination.

That is, in the state in which it is not the drift driving situation, i.e., in the state in which the vehicle is drifting but it is determined that left and right wheel speed control in the driving situation is turned off and thus the off flag bLRSCDrv OFF is generated, when the driver's requested torque τ_{□□□} is a negative (−) value (τ_{□□□}<0), and the left and right wheel speed difference e_{Vwhl} is less than the target left and right wheel speed difference e_{Vwhl}* (e_{Vwhl}<e_{Vwhl}*) during a left turn or the left and right wheel speed difference e_{Vwhl} is greater than the target left and right wheel speed difference e_{Vwhl}*(e_{Vwhl}>e_{Vwhl}*) during a right turn, it is determined that left and right speed control is on in the braking situation, and thus the on flag bLRSCDrv ON is generated.

Furthermore, when drift is released, or when the driver's requested torque τ_{□□□} is a positive (+) value (τ_{□□□}>0), or the left and right wheel speed difference e_{Vwhl} is greater than or equal to a value obtained by adding the target offset amount Δ to the target left and right wheel speed difference e_{Vwhl}*(e_{Vwhl}≥e_{Vwhl}*+Δ) during a left turn or the left and right wheel speed difference e_{Vwhl} is less than or equal to a value obtained by subtracting the target offset amount Δ from the target left and right wheel speed difference e_{Vwhl}*(e_{Vwhl}≤e_{Vwhl}*−Δ) during a right turn, it is determined that left and right speed control is off in the braking situation, and thus the off flag bLRSCDrv OFF is generated.

At the present time, depending on a regenerative braking operation for each vehicle specifications, there may be a case in which the requested torque is 0 for a vehicle not using regenerative braking torque when braking. In determining braking drift release, it is determined that left and right speed control is off in consideration of hysteresis in the left and right wheel speed difference, including a case in which the requested torque is greater than 0, and thus a corresponding flag bLRSCBrk OFF (extremely low speed control OFF) is generated. Furthermore, at an extremely low speed at which a drift situation will not occur, it is determined that left and right speed control is off in consideration of a speed signal, and thus the flag bLRSCBrk OFF is generated.

Furthermore, the left and right wheel speed difference error Err is determined during braking, and this is determined as a difference between the target left and right wheel speed difference e_{Vwhl}* and the left and right wheel speed difference e_{Vwhl} (Err=e_{V}_{_{whl}}*−e_{Vwhl}).

Subsequently, the drift torque vectoring controller 30 is configured to determine a target yaw moment to follow the target left and right wheel speed difference e_{Vwhl}*. For the present purpose, PID control may be implemented, and at the instant time, the I control is performed only in a direction of increasing external wheel control, and in other situations, a I control value is gradually reduced.

Shaping and yaw moment limit are performed depending on a direction of increasing or decreasing the driver's requested torque, and at the instant time, the I control and shaping depending on the direction thereof reduce the sense of difference when the accelerator pedal is turned off in a drift situation, secure linearity in the yaw motion of the vehicle felt by the driver in response to accelerator pedal input, and controls sensitivity of the yaw motion of the vehicle to the accelerator pedal input.

Driver's requested torque-based shaping, i.e., shaping depending on the direction of increasing or decreasing the driver's requested torque τ_{□□□}, is intended to further secure drift driving emotion felt by the driver in left and right speed control. Although left and right speed control may be accurately performed, from the driver's perspective, i.e., from a driving emotional aspect, better emotion may be realized if the yaw moment for left and right speed control varies depending on the driver's accelerator pedal input.

That is to say, left and right wheel speed control (eLSD) may be good control but may not be optimal, and to implement better emotion, the yaw moment may be shaped depending on a driver's intention, and for the present purpose, shaping is performed based on the driver's requested torque.

This left and right speed control is operated above a designated wheel speed difference to synchronize the left and right wheel speeds, and may be referred to as control to ensure yaw motion linearity depending on accelerator pedal input.

However, in securing yaw motion linearity, a similar role may be performed in a different method through other controls for additional control freedom other than the direction of synchronizing the left and right wheel speeds, and in the instant case, left and right speed control may not be performed in a situation in which the wheel speed difference is not greater than a given left and right wheel speed difference threshold but is performed only when the left and right wheel speed difference is too great, and therefore, the control amount in left and right speed control may be small.

Referring to FIG. 5, in determining the target yaw moment, when left and right wheel speed difference control is on (bLRSCDrv ON, bLRSCBrk ON), PID control and anti-windup are performed. Anti-windup itself is technology which is known to those skilled in the art, and a detailed description thereof will thus be omitted.

In PID control, the P gain K_{P} may be determined by a map based on the left and right wheel speed difference error Err and the vehicle speed, the I gain K_{I} may be determined by a map based on the integral value of the left and right wheel speed difference error Err and the vehicle speed, and the D gain K_{D} may be determined by a map based on the differential (filtered) value of the left and right wheel speed difference error Err and the vehicle speed.

Furthermore, when left and right wheel speed difference control is off (bLRSCDrv OFF, bLRSCBrk OFF), zeroing of the control amount may be performed. Furthermore, in determining the target yaw moment, limitation on the maximum yaw moment, driver's requested torque-based shaping, limitation on the yaw moment direction depending on the left or right turning direction, and the like may be performed.

Accordingly, the drift torque vectoring controller 30 may be configured to determine the target yaw moment M_{□□□□□}* for left and right speed control (LRSC) through the above-described process.

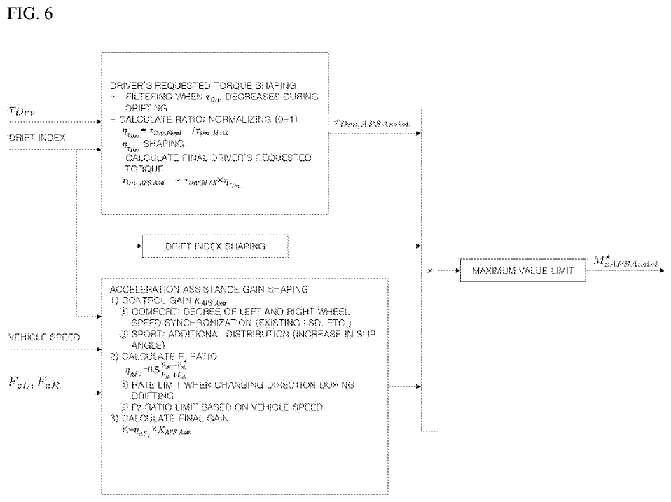

Next, FIG. 6 is a diagram for explaining a method of performing acceleration assistance during drift control according to an exemplary embodiment of the present disclosure.

In addition to left and right speed control like general clutch control, the apparatus according to an exemplary embodiment of the present disclosure assists a driver's drift action. Generally, a driver performs two actions, i.e., acceleration and steering, through driving input, and the apparatus is configured to perform assistance to these two actions to assist the driver in drift driving the vehicle.

First, to describe acceleration assistance, the drift torque vectoring controller 30, for acceleration assistance, utilizes the driver's requested torque τ_{□□□}, which is determined based on the vehicle driving information including driver input values, the drift index DRIFTIndex, the vehicle speed, and the vertical force F_{□□} of the left wheel and the vertical force F_{□□} of the right wheel, as inputs.

Furthermore, the drift torque vectoring controller 30 may shape the driver's requested torque τ_{□□□} to secure sensitivity and linearity of the acceleration-based (accelerator pedal input value (APS value)-based) yaw motion through driver acceleration assistance.

Because the yaw moment may be maintained depending on the vehicle and the situation when the accelerator pedal is off, filtering is performed when the driver's requested torque τ_{□□□} decreases during drifting to prevent the acceleration-based yaw motion from being too sensitive.

Thereafter, for normalization to 0 to 1, a normalization ratio η_{τ□□□} is determined as a value obtained by dividing the driver's requested torque (A filtered requested torque τ_{Drv,Filtered}) by the maximum driver's requested torque τ_{Drv,MAX} (η_{τ□□□}=τ_{Drv,Filtered}/τ_{Drv,MAX}).

Here, the maximum driver's requested torque τ_{Drv,MAX} is the maximum motor torque, which is determined when the accelerator pedal is depressed to the maximum, and the maximum driver's requested torque τ_{Drv,MAX} may be determined as the maximum torque set due to the characteristics of motor hardware, or as the maximum motor torque having a limited value used in the drift mode.

To compensate for non-linearity in which the yaw moment required to increase stability of the vehicle varies depending on the degree of acceleration by the driver, a final driver's requested torque τ_{APS Assist} for acceleration assistance may be determined by determining the normalization ratio η_{τ□□□} for the driver's requested torque τ_{□□□}, shaping the normalization ratio η_{τ□□□}, and then multiplying the maximum driver's requested torque τ_{Drv,MAX} by the shaped normalization ratio η_{τ□□□} (τ_{APS Assist}=τ_{Drv,MAX}×η_{τ□□□}). At the instant time, in addition to shaping of the driver's requested torque, accelerator pedal sensor (APS) signal (accelerator pedal input value)-based shaping is also possible.

Furthermore, because the previously determined drift index DRIFTIndex is intended to determine and estimate the drift situation as rapidly and accurately as possible, the drift index DRIFTIndex may be additionally shaped to shape the slope of a target yaw moment M_{zAPS Assist}* for acceleration assistance control.

Thereafter, the target yaw moment M_{zAPS Assist}* for acceleration assistance control is determined by multiplying the final driver's requested torque τ_{APS Assist} for acceleration assistance by the shaped drift index DRIFTIndex and an acceleration assistance gain K, and at the instant time, linearity of the acceleration-based yaw motion when entering and releasing drift may be secured depending on the transition slope of the shaped drift index DRIFTIndex.

Here, the acceleration assistance gain K is determined as the product of a control gain K_{APS Assist} and a vertical force ratio η_{[(ΔF)}_{_{□}}, and first, the control gain K_{APS Assist} may be determined depending on the drift control mode as follows.

Drift comfort: Drift at the level of left and right wheel speed synchronization equivalent to general clutch torque vectoring (the conventional LSD, etc.)

Drift sport: Virtual steering angle kit tuning effect through additional torque distribution (larger lateral slip angle drift driving being possible compared to the same accelerator pedal input value (APS value))

General drifters enjoy drifting after tuning a rear wheel torque and a steering angle kit (to exhibit the maximum front wheel steering angle) to easily drift even at a larger lateral slip angle.

Through the present acceleration assistance control, it is possible to provide two or more kinds of marketability with the same vehicle, and in the future, the driver may customize a desired degree of drifting in addition to selection among the two selectable modes through an interface such as a knob, and thus, additional marketability (virtual steering angle kit effect) may be provided.

The vertical force ratio η_{[(ΔF)}_{_{□}} indicates the rate (degree) of turn of the vehicle based on the vertical forces of the left and right wheels, and is determined as the ratio of the difference F_{□□}-F_{□□} between the vertical force F_{□□} of the left wheel and the vertical force F_{□□} of the right wheel to the sum F_{□□}+F_{□□} of the vertical force F_{□□} of the left wheel and the vertical force F_{□□} of the right wheel (η_{ΔF}_{_{□}}=0.5×[(F_{□□}−F_{zL})/(F_{zR}+F_{□□})]), and when changing the direction of the vehicle in FIG. 8 drift driving, as shown in FIG. 3, the vertical force ratio η_{[(ΔF)}_{_{□}} may be determined by first limiting the slope thereof and then additionally limiting the slope thereof based on the vehicle speed.

When the acceleration assistance gain K is determined by multiplying the control gain K_{APS Assist} by the vertical force ratio η_{[(ΔF)}_{_{□}} (K=η_{[(ΔF)}_{_{□}}×K_{APS Assist}), the final driver's requested torque τ_{APS Assist} is multiplied by the shaped drift index DRIFTIndex and the acceleration assistance gain K, and the target yaw moment M_{zAPS Assist}* for acceleration assistance control is determined by limiting the maximum value of the obtained product.

At the present time, to implement a yaw motion which is more intuitive to the driver's intention, acceleration assistance control may be used as main control and left and right speed control may be used as auxiliary control by increasing an acceleration assistance control amount and decreasing a left and right speed control amount, allowing the complementary role of limiting the left and right wheel speed difference in necessary situations to be performed.

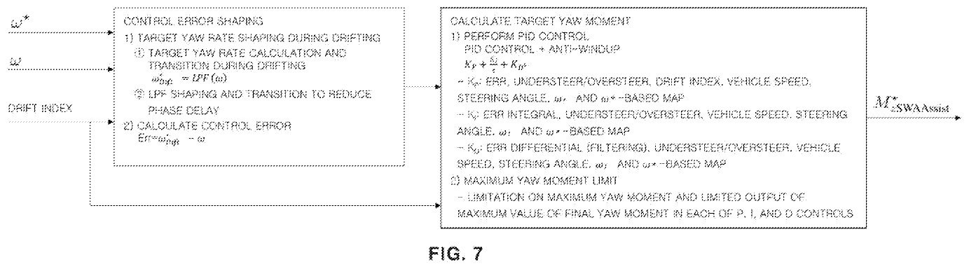

Next, FIG. 7 is a diagram for explaining a method of performing steering assistance during drift control according to an exemplary embodiment of the present disclosure.

Drifting is a vehicle behavior to enjoy handling in an unstable area, and because drifting itself represents a very rapid vehicle behavior, there is a clear barrier to entry in terms of driving ability for ordinary drivers to drift.

Furthermore, there are barriers to entry in terms of preparation for drift driving due to costs incurred due to tire wear and the need to secure a wide road surface (drift paddock, etc.), and thus, opportunities for drift driving for general drivers are very limited.

Therefore, the present disclosure assists driver's steering so that a vehicle may more smoothly enter, maintain, and release drift by overcoming the inexperienced driving skills of ordinary drivers or the momentary steering mistakes of experienced drivers.

The driver who applies wheel spin to the rear wheel with the accelerator pedal takes a steering action to maintain the vehicle's yaw rate in a desired direction and to adjust the vehicle's turning radius. An insufficient or excessive steering action may prevent the required amount of countersteer from being accurately adjusted, thus resulting in a sudden behavior and making it difficult to enter/maintain/release drift. Therefore, to prevent the yaw motion felt by the driver from occurring too suddenly, control to limit the high-frequency component of the yaw motion is performed.

To the present end, in an exemplary embodiment of the present disclosure, filtering to remove a high-frequency region from a current yaw rate is performed to maintain a target yaw rate during drifting. At the instant time, it is possible to use not only the current yaw rate but also a combination of the current yaw rate and signals, such as the target yaw rate, the vehicle lateral acceleration A_{y}, and the lateral slip angle change rate \dot{β}. Thereafter, an error between the determined target yaw rate and the current yaw rate is determined to perform PID control (or general nonlinear control, or the like).

Therethrough, the driver may feel the yaw motion below a designated bandwidth, and may thus make it possible to implement drift driving more smoothly and easily, and thereby, the driver feels smoother drift driving emotion.

To describe steering assistance in more detail with reference to FIG. 7, first, the drift torque vectoring controller 30 utilizes the vehicle yaw rate ω, the target yaw rate ω*, and the drift index DRIFTIndex as inputs, for steering assistance.

The drift torque vectoring controller 30 is configured to determine a control error, and for the present purpose, is configured to determine a drift target yaw rate ω_{□□□□□}* based on the current vehicle yaw rate ω.

That is, for more comfortable drift maintenance performance during drifting, the drift target yaw rate ω_{□□□□□}* is determined by appropriately filtering the current vehicle yaw rate ω depending on the situation, and in the instant case, a low-pass filter (LPF) may be used. Here, determination of the drift target yaw rate ω_{□□□□□}* and transition may be expressed as an equation “ω_{□□□□□}*”, as shown in FIG. 7.

Thereafter, to reduce phase delay caused by the low-pass filter (LPF) during FIG. 8 drifting, as shown in FIG. 3, filtered value shaping and transition depending on the situation are performed.

Subsequently, a yaw rate control error Err is determined, and in the instant case, the yaw rate control error Err may be determined as a difference value obtained by subtracting the current vehicle yaw rate ω from the drift target yaw rate ω_{□□□□□}* (Err=ω_{□□□□□}*−ω).

Thereafter, in determining a target yaw moment M_{zSWA Asisst}* for steering assistance control, PID control and anti-windup may be performed, and in the instant case, the P gain K_{P} in PID control may be determined by a map based on the yaw rate control error Err, the drift index DRIFTIndex, the vehicle speed, the steering angle, the yaw rate ω, and the target yaw rate ω*.

Furthermore, the I gain K_{I} may be determined by a map based on the integral value of the yaw rate control error Err, information regarding understeer and oversteer, the vehicle speed, the steering angle, the yaw rate ω, and the target yaw rate ω*, and the D gain K_{D} may be determined by a map based on the differential (filtered) value of the yaw rate control error Err, the vehicle speed, the steering angle, the yaw rate ω, and the target yaw rate ω*.

Furthermore, in determining the target yaw moment M_{□□□□□□□□□□}* for steering assistance control, limitation on the maximum yaw moment and limited output of the maximum value of the final yaw moment in each of P, I, and D controls may be performed.

Accordingly, the drift torque vectoring controller 30 may be configured to determine the target yaw moment M_{zSWA Asisst}* for steering assistance control through the above-described process.

Next, FIG. 8 is a diagram for explaining a yaw damping control method in drift control according to an exemplary embodiment of the present disclosure.

As shown the present figure, the drift torque vectoring controller 30 utilizes a real-time vehicle speed Vₓ, a vehicle yaw acceleration \dot{ω} or the lateral slip angle change rate \dot{β}, and the vehicle yaw rate ω as inputs for yaw damping.

First, a target yaw acceleration \dot{ω}* or a target lateral slip angle change rate \dot{β} *, which is a damping target corresponding to the current real-time vehicle speed Vₓ, is determined. Here, setting information, such as a map or a function that predefines the correlation between the vehicle speed Vₓ and the target yaw acceleration \dot{ω}* or between the vehicle speed Vₓ and the target lateral slip angle change rate \dot{β} * may be used. The target yaw acceleration \dot{ω}* or the target lateral slip angle change rate \dot{β} * corresponding to the current real-time vehicle speed Vₓ may be determined by the setting information, such as the map or the function.

When the target yaw acceleration \dot{ω}* or the target lateral slip angle change rate \dot{β} * is determined, the current yaw acceleration \dot{ω} or lateral slip angle change rate \dot{β} of the vehicle is compared with the target yaw acceleration \dot{ω}* or the target lateral slip angle change rate \dot{β} *, which is the damping target corresponding to the current real-time vehicle speed Vₓ, and thereby, a yaw acceleration error e_{\dot{ω}} or a lateral slip angle change rate error e_{\dot{β}} is determined.

Although FIG. 8 only shows determination of the yaw acceleration error e_{\dot{ω}}, the yaw acceleration \dot{ω} may be replaced by the lateral slip angle change rate \dot{β} in the block where the yaw acceleration error e_{\dot{ω}} is determined, and in the instant case, the damping target is the target lateral slip angle change rate \dot{β}*. Furthermore, the yaw acceleration error e_{\dot{ω}} may be replaced by the lateral slip angle change rate error e_{\dot{β}}.

In a process of determining the yaw acceleration error e_{\dot{ω}} (or the lateral slip angle change rate error e_{\dot{β}}), when the current vehicle yaw acceleration \dot{ω} is greater than the target yaw acceleration \dot{ω}*, which is the damping target, the yaw acceleration error e_{\dot{ω}} may be determined as a value obtained by subtracting the current vehicle yaw acceleration \dot{ω} from the target yaw acceleration \dot{ω}*, which is the damping target.

Furthermore, when the current vehicle yaw acceleration \dot{ω} is less than a value −\dot{ω}* obtained by multiplying the target yaw acceleration \dot{ω} * by −1, the yaw acceleration error e_{\dot{ω}} may be determined as a value obtained by subtracting the current vehicle yaw acceleration \dot{ω} from the value −\dot{ω}* obtained by multiplying the target yaw acceleration \dot{ω} * by −1. In other cases, the yaw acceleration error e_{\dot{ω}} may be determined as 0.

When the yaw acceleration error e_{\dot{ω}} (or the lateral slip angle change rate error e_{\dot{β}}) is determined as above, a target yaw moment for yaw damping control is determined based on the yaw acceleration error e_{\dot{ω}}. Here, control to limit the yaw acceleration or the lateral slip angle change rate to a certain value or less may be performed to achieve yaw damping.

Although FIG. 8 shows only P control, it is possible to use not only P control but also various follow-up controls, including PID control, to obtain a target yaw moment to make a current value follow a target value using an error.

When the maximum motor torque is insufficient compared to the weight, it is very difficult to stabilize the yaw motion in a transition situation that occurs during drifting, as in the example shown in FIG. 3. This is because there is a section where tire lateral force is rapidly recovered due to a lack of driving torque during drifting transition lateral behavior, thus causing a reverse turn.

To solve the present problem, in an exemplary embodiment of the present disclosure, a torque level required to maintain rear wheel slip is reduced by simultaneously applying driving force (longitudinal force) Fₓ of the vehicle to reduce a rear wheel friction circle. Here, the applied driving force may have eighter positive (+, driving) or negative (−, braking) values.

Furthermore, it is possible to determine and apply appropriate driving force Fₓ along with the target yaw moment required for yaw damping control by applying the driving force (longitudinal force) Fₓ proportional to the target yaw moment, and thereby, in the case of a vehicle with insufficient driving force, necessary yaw damping performance may be secured by generating an appropriate braking torque depending on the situation and applying the braking torque to vehicle wheels. That is, yaw damping performance may be secured by setting a control strategy for the driving force Fₓ depending on the torque and weight ratio of the vehicle.

At the present time, to control the driving force (longitudinal force) Fₓ of the vehicle, a transition index IDX is generated by adding a value obtained by multiplying the filtered value of the yaw acceleration \dot{ω} or the lateral slip angle change rate \dot{β} by a gain K_{\dot{β}}, and a value obtained by multiplying the product of the yaw rate ω and the yaw acceleration \dot{ω} by a gain K_{\dot{β}ω}. Here, the gain K_{\dot{β}} is a lateral slip angle change rate (or yaw acceleration) component gain, and the gain K_{\dot{β}ω} is a “lateral slip angle change rate (or yaw acceleration)×yaw rate” component gain.

The transition index IDX may indicate a degree of smooth connection (through addition of the yaw acceleration component) between sections in which situations occur during transition before and after a neutral steer point (a point where the vehicle yaw rate is 0 during transition).

As shown in FIG. 8, a low-pass filter (LPF) may be used to filter the yaw acceleration \dot{ω} or the lateral slip angle change rate \dot{β}, and the gain K_{\dot{β}} is applied to the yaw acceleration or the lateral slip angle change rate shaped by the low-pass filter.

When the transition index IDX is generated as above, a yaw damping driving force gain K_{□□} to determine a moment bias ratio (MBR) may be determined based on the transition index IDX. Here, the yaw damping driving force gain K_{□□} may be said to be a gain of a driving force ratio applied when a yaw moment for yaw damping is generated.

Here, setting information, such as a map or a function that predefines the correlation between the transition index IDX, which is an input, and the yaw damping driving force gain K_{□□}, which is an output, may be used, as shown in FIG. 8. Accordingly, the value of the yaw damping driving force gain K_{□□} corresponding to the transition index IDX may be determined using the setting information, such as the map.

Although the gain may be determined based on the transition index IDX, as described above, a method, in which gains are determined using setting information based on respective components forming the transition index IDX and then the gains are added, may also be applied.

Here, the gain value on the component side, obtained by multiplying the yaw rate by the yaw acceleration, may be generated as a negative number before the neutral steer point, and as a positive number after the neutral steer point, and the driving force Fₓ may be generated by determining the control amount K_{□□} based on the present gain value.

Furthermore, the respective wheel torques (a left wheel torque and a right wheel torque) of the vehicle may be determined by the generated target yaw moment and target driving force Fₓ for yaw damping control to the respective wheels of the vehicle. Consequently, the target wheel torque of the left wheel and the target wheel torque of the right wheel may be determined from a target wheel torque for yaw damping control.

Here, appropriate yaw damping performance may be provided by tuning driving and braking control amounts depending on vehicle behavior characteristics using the control amount K_{□□}. Furthermore, the determined moment bias ratio (MBR) includes a driving force bias ratio (Fₓ bias ratio) determined when generating and applying the yaw moment, and is a wheel torque distribution ratio in consideration of application of driving force Fₓ (considering bias). In an exemplary embodiment of the present disclosure, the determined moment bias ratio (MBR) may mean the wheel torque application ratio of the rear wheel.

This yaw damping control is in charge of yaw damping in a drift transition section, and the above-described steering assistance control is in charge of yaw damping to maintain drift.

FIG. 8 shows that the target yaw moment determined as described above may be used in determining the target wheel torque of the left wheel (yaw damping target wheel torque L) and the target wheel torque of the right wheel (yaw damping target wheel torque R) from the target wheel torque for yaw damping control.

In more detail, the target wheel torque is determined using the target yaw moment for yaw damping control, a half track width T, and an effective dynamic radius value r_{eff} of the wheels, and the target wheel torque is determined as a value obtained by multiplying a value r_{eff}/T, obtained by dividing the effective dynamic radius value r_{eff} by the half track width T, by the target yaw moment.

Furthermore, the determined target wheel torque and the yaw damping driving force gain K_{□□} are used to determine the moment bias ratio (MBR), the moment bias ratio (MBR) is determined as a value of “MBR=0.5+0.5×K_{□□}” when the target wheel torque is 0 or more, and the moment bias ratio (MBR) is determined as a value of “MBR=0.5−0.5×K_{□□}” when the target wheel torque is less than 0.

Accordingly, when the target wheel torque is distributed to the left wheel and the right wheel using the determined moment bias ratio (MBR), the target wheel torque of the left wheel (yaw damping target wheel torque L) and the target wheel torque of the right wheel (yaw damping target wheel torque R) for yaw damping may be determined.

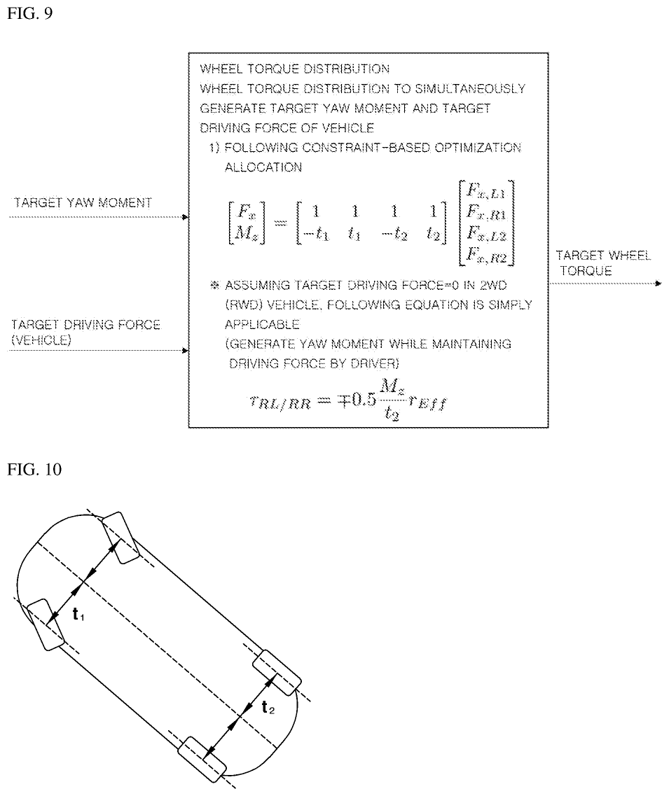

Next, FIG. 9 and FIG. 10 are diagrams for explaining a target yaw moment coordination and target wheel torque determination method in drift control according to an exemplary embodiment of the present disclosure.

The target yaw moment determined as above must be distributed as respective wheel torques. When there are the target yaw moment and the target driving force of the vehicle, the two forces may be distributed as the respective wheel torques, as shown in the equation illustrated in FIG. 9. Distribution may be performed further using a vehicle dynamics model by further elaborating the present equation and configuring logic.

To satisfy these distribution conditions, torque allocation is performed using optimization, or the like. FIG. 9 shows an example of torque allocation using optimization, and shows that wheel torque distribution is performed using the half track widths of the front and rear wheels from the target yaw moment M_{z} and the target driving force Fₓ, which are inputs. In FIG. 9, * represents a target value.

The target yaw moment distributed as the wheel torques in the present operation is a target yaw moment for drift control which is the sum of the target yaw moment for left and right speed control, the target yaw moment for acceleration assistance control, and the target yaw moment for steering assistance control which were determined previously. At the instant time, the target yaw moment for yaw damping may be used, as shown in FIG. 8, to form the wheel torques in consideration of the driving force, and in the instant case, may be added to the final target wheel torques distributed in FIG. 9 to implement yaw damping.

As an exemplary embodiment of the present disclosure, the target yaw moment for yaw damping may also be considered in “Allocation” of FIG. 9, i.e., the target yaw moment of FIG. 9 may be the final target yaw moment for drift control which is the sum of the target yaw moment for left and right speed control, the target yaw moment for acceleration assistance, the target yaw moment for steering assistance control, and the target yaw moment for yaw damping control to determine the target wheel torques using “Allocation” in FIG. 9, and “Allocation” may be performed by applying distribution logic to distribute the target yaw moment for yaw damping into the wheel torques in consideration of the driving force.

In FIG. 9, t₁ and t₂ represent the half-track widths of the front wheels and the rear wheels, and the half-track width is a horizontal distance in the axle direction from the center of mass of the vehicle to each wheel position, as shown in FIG. 10.

In an exemplary embodiment of the present disclosure, additional target driving force required for application to a 2WD vehicle is assumed to be 0, and the present method is a method of performing torque vectoring by generating only yaw moment to maintain driver's driving force corresponding to a driver's intention.

For example, in the case of a rear-wheel drive (2WD) vehicle, half of the target yaw moment M_{z} is divided by the half track width t₂ of the rear wheels to be converted into tire force, the tire force is multiplied by the effective dynamic radius r_{eff} of the wheels to be converted into a torque, and the torque is determined as the target wheel torque (T_{RL/RR}=τ_{L}, τ_{RR}) of the rear wheels, and is used to control a rear wheel torque.

Here, when torque in the same direction as the target yaw moment is applied to the right wheels, and torque in the negative direction is applied to the left wheels, the same coordinate system as in the target yaw moment (the ISO coordinate system) may be used. by forming the control direction from the vehicle perspective regardless of the driving direction of a motor system assigned to the vehicle, control logic independent of hardware HW may be configured.

Among the control blocks described above with reference to FIGS. 5 to 8, the target yaw moment alone is generated except for yaw damping control. Only in yaw damping control shown in FIG. 8, wheel torques are output along with the target yaw moment, and the target yaw moment may be converted into the wheel torques through the above-described wheel torque distribution determination.

Furthermore, appropriate driving force Fₓ may be provided in an integrated way when generating the yaw moment through “Target wheel torque conversion considering driving force (Fₓ) during turning” in yaw damping control, as shown in FIG. 8. That is, “Target wheel torque conversion considering driving force (Fₓ) during turning” in yaw damping control may be used in the above-described left and right speed control, acceleration assistance control, and steering assistance control, and this means that longitudinal control is also used in terms of each control concept.

Accordingly, the advantages of left and right torque vectoring are maximized. That is, in the case of clutch torque vectoring, control may be performed only in the direction of left and right wheel speed synchronization, but in the case of motor torque vectoring using independent left and right torque vectoring, performance beyond left and right wheel speed synchronization may be implemented based on drift control in which left and right wheel torques are independently controllable according to an exemplary embodiment of the present disclosure.

In the present way, the method of controlling drift of the vehicle according to an exemplary embodiment of the present disclosure has been described in detail, and the present disclosure exhibits the following effects.

In the case of existing clutch-based drift control, as a driver accelerates a vehicle by synchronizing left and right wheel speeds, the vehicle is controlled to have linear yaw motion. However, because the present drift situation itself is a very nonlinear area, a barrier to entry for ordinary drivers to drift is high. Therefore, it takes a lot of practice for ordinary drivers to overcome the present barrier to entry and drift.

However, if the method of controlling drift according to an exemplary embodiment of the present disclosure is applied, the advantages of a motor are utilized to the fullest extent through motor-based drift control and torque vectoring, drift entry, maintenance, release and transition may be easily performed, and vehicle marketability that allows ordinary drivers to enjoy drifting even with a small amount of practice may be provided.

In determination of drift in an exemplary embodiment of the present disclosure, the timing of determination may be advanced compared to determination of drift in the conventional drift control (Steering angle×Yaw rate <0), and a control amount may be determined and smoothing may be performed in drift entry and release by determining a drift index by adjusting the slope thereof and then using the determined drift index for control.

General clutch-based drift performance may be secured based on left and right speed control, and acceleration control and steering control may assist a driver in maintaining drift more easily even when the driver makes a mistake or is an inexperienced driver.

Additional yaw damping control is used to limit an excessive yaw acceleration or lateral slip angle change rate which may occur in the transition situation shown in FIG. 3, making it possible to more easily transition in the opposite direction and maintain drift during FIG. 8 drifting.

Furthermore, the control amount may be customized beyond the comfort and sports modes, being configured for providing various modes from a mode in which beginners may easily use drift to a mode in which experts want to enjoy nonlinearity of a vehicle.

Although, in the above-described control process of the present disclosure, the target yaw moment and the target driving force Fₓ are determined by converting vehicle physical values (a motor torque, a motor revolutions per minute (rpm)↔a wheel torque, a wheel speed) through input and output mapping, and are then converted into the wheel torque, the motor torque may be directly determined and transmitted without interface mapping. Furthermore, all wheel speed (wheel speed difference) control may be performed through motor RPM control.

Furthermore, in determining a drift situation, the drift situation may be determined and estimated based on various combinations of the yaw rate, the yaw acceleration error, and the lateral slip angle change rate.

In left and right speed control, the target left and right wheel speed difference may be set in various ways depending on the situation. The left or right turning direction may be determined not only through a difference in vertical force F_{z} but also through various signals, such as the steering angle, the yaw rate, and the lateral acceleration A_{y}.

In acceleration assist control, torque shaping may be performed based on the accelerator pedal input value (APS value) instead of the driver's requested torque. The vertical force ratio may also be determined through a combination of various signals, such as the steering angle, the yaw rate, the lateral acceleration A_{y}, and the like. Although, in the case of above-described logic, the comfort and sports modes are presented as examples, customization may also be done using a knob or a user switch.

To explain in more detail, beginner drivers are less skilled in drifting and prefer stability, but experienced drivers may feel a sense of difference because it is difficult to generate agile drift diving if drift is too stable. If the method according to an exemplary embodiment of the present disclosure is used, a function of tuning or customizing acceleration assistance control and steering assistance control depending on the mode may be provided.

Furthermore, the low-pass filter (LPF) for steering assistance may perform various filtering, and a filtering target may be determined using not only the yaw rate but also the lateral slip angle change rate or a combination of the yaw rate and the lateral slip angle change rate.

In the case of yaw damping control, both the yaw rate and the lateral slip angle change rate may be used, and the weighted sum of the two components may be used. Although yaw acceleration-based P control is performed in an exemplary embodiment of the present disclosure, various linear and nonlinear controls in addition to yaw acceleration-based PID control may be used to perform the role of control according to an exemplary embodiment of the present disclosure.

If input and output interface mapping is modified based on other actuators, such as a clutch, the control process according to an exemplary embodiment of the present disclosure may be applied to various actuator-based handling control other than motor-based control.

Furthermore, parameters for each module may be customized and provided in various user modes, and thereby, it is possible to provide features-on-demand (FoD).

As is apparent from the above description, a method of controlling drift of a vehicle according to an exemplary embodiment of the present disclosure may more easily secure optimal drift entry, maintenance, release, and transition performance regardless of driving and braking in an electric vehicle provided with a motor-based drive system, and may implement sufficient yaw damping performance even in a transition situation which is a limitation in existing vehicles.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling drift of a vehicle, the method comprising:
determining, by a controller, whether a current driving situation of the vehicle is a drift entry situation or a release situation based on vehicle driving information configured to indicate a current driving state of the vehicle, and generating a drift index configured to indicate a current degree of the drift from a result of the determining;
determining, by the controller, a target yaw moment for left and right speed control depending on a driving situation or a braking situation of the vehicle and target yaw moments for drift assistance control depending on a driver input and a vehicle state in the drift entry situation, based on the vehicle driving information; and
generating and outputting, by the controller, a target torque of a motor configured to drive each wheel of the vehicle based on the determined target yaw moments.

2. The method of claim 1, wherein the determining whether the current driving situation of the vehicle is the drift entry situation or the release situation includes:
determining a steering-based target yaw rate based on a steering angle and a vehicle speed among the vehicle driving information;
determining a steering-based target yaw acceleration based on the determined steering-based target yaw rate;
determining a vehicle yaw acceleration from a vehicle yaw rate detected by a sensor among the vehicle driving information;
estimating a vehicle lateral slip angle based on the vehicle driving information, and obtaining a lateral slip angle change rate from the estimated vehicle lateral slip angle or obtaining the lateral slip angle change rate using vehicle dynamics information;
determining a yaw acceleration error which is a difference between the steering-based target yaw acceleration and the vehicle yaw acceleration, and a yaw rate error which is a difference between the steering-based target yaw rate and the vehicle yaw rate; and
determining whether the current driving situation of the vehicle is the drift entry situation based on the yaw acceleration error, the yaw rate error, and the lateral slip angle change rate.

3. The method of claim 2, wherein, in the determining whether the current driving situation of the vehicle is the drift entry situation, the controller concludes that the current driving situation of the vehicle is the drift entry situation, in response that all of a first condition, a second condition, and a third condition are satisfied,
wherein the first condition is a condition in which an absolute value of the yaw acceleration error exceeds a predetermined yaw acceleration error threshold,
wherein the second condition is a condition in which an absolute value of the lateral slip angle change rate exceeds a predetermined lateral slip angle change rate threshold and a product of the lateral slip angle change rate and a vehicle lateral acceleration detected by a sensor is 0 or less, and
wherein the third condition is a condition in which an absolute value of the yaw rate error exceeds a predetermined yaw rate error threshold and a product of the yaw rate error and the vehicle lateral acceleration is 0 or less.

4. The method of claim 2, further including:
determining, by the controller, a drift target yaw rate based on the vehicle yaw rate; and
determining, by the controller, whether the current driving situation of the vehicle is the drift release situation based on the yaw rate error, the drift target yaw rate, the steering-based target yaw rate, and the vehicle yaw rate.

5. The method of claim 4, wherein, in the determining whether the current driving situation of the vehicle is the drift release situation, the controller concludes that the current driving situation of the vehicle is the drift release situation, in response that all of a first condition, a second condition, and a third condition are satisfied,
wherein the first condition is a condition in which the absolute value of the yaw rate error is less than or equal to the predetermined yaw rate error threshold,
wherein the second condition is a condition in which a product of the drift target yaw rate and the yaw rate is greater than or equal to a predetermined yaw rate product threshold, and
wherein the third condition is a condition in which an absolute value of a difference between the steering-based target yaw rate and the drift target yaw rate is less than or equal to a predetermined yaw rate difference threshold.

6. The method of claim 1, wherein the determining the target yaw moment for left and right speed control includes:
determining a target left and right wheel speed difference depending on the driving situation or braking situation of the vehicle based on wheel speeds of a left wheel and a right wheel, a vehicle speed, and a target internal wheel slip amount depending on a turning direction of the vehicle;
determining a left and right wheel speed difference from the wheel speeds of the left wheel and the right wheel, and determining the turning direction of the vehicle from vertical forces of the left wheel and the right wheel or a longitudinal acceleration and a lateral acceleration of the vehicle;
determining whether the left and right speed control is on or off and a left and right wheel speed difference error depending on the driving situation or braking situation of the vehicle based on the determined target left and right wheel speed difference, the determined left and right wheel speed difference, and the determined turning direction of the vehicle; and
determining a target yaw moment configured to cause the left and right wheel speed difference to follow the target left and right wheel speed difference in an ON state of the left and right speed control.

7. The method of claim 6, wherein, in the determining the target left and right wheel speed difference:
in case of the driving situation of the vehicle, the target left and right wheel speed difference is determined as a value corresponding to a difference between an free wheel speed of the left wheel and an free wheel speed of the right wheel or the vehicle seed; and
in case of the braking situation of the vehicle, the target left and right wheel speed difference is determined as a value corresponding to a difference between a target internal wheel speed, determined from the target internal wheel slip amount depending on the turning direction of the vehicle among the left wheel and the right wheel and the vehicle speed, and an external wheel speed.

8. The method of claim 6, wherein, in the determining whether the left and right speed control is on or off and the left and right wheel speed difference error:
whether the left and right speed control is on or off is determined depending on the turning direction based on the target left and right wheel speed difference, the left and right wheel speed difference, a driver's requested torque, and a target internal wheel torque for torque vectoring control; and
the left and right wheel speed difference error is determined depending on the turning direction based on the target left and right wheel speed difference and the left and right wheel speed difference.

9. The method of claim 1, wherein, in the determining the target yaw moment for left and right speed control and the target yaw moments for drift assistance control, the drift assistance control depending on the driver input and the vehicle state in the drift entry situation includes:
acceleration assistance control and steering assistance control configured to assist the vehicle in drifting depending on the driver input and the generated drift index; and
yaw damping assistance control configured to assist the vehicle in drifting depending on the vehicle speed and a vehicle yaw rate.

10. The method of claim 9, wherein, in the determining a target yaw moment for the acceleration assistance control, the target yaw moment for the acceleration assistance control is determined using a driver's requested torque determined based on the vehicle driving information, the drift index, a vehicle speed, vertical force of a left wheel, and vertical force of a right wheel, as inputs.

11. The method of claim 10, wherein the determining the target yaw moment for the acceleration assistance control includes:
normalizing the driver's requested torque by determining a normalization ratio which is a ratio of a filtered driver's requested torque, obtained by filtering the driver's requested torque, to a maximum driver's requested torque;
determining a driver's requested torque for the acceleration assistance control as a value obtained by multiplying the normalization ratio by the maximum driver's requested torque;
determining a gain for the acceleration assistance control based on the vehicle speed, vertical force of the left wheel, and vertical force of the right wheel; and
determining the target yaw moment for the acceleration assistance control based on the determined driver's requested torque for the acceleration assistance control, the determined gain for the acceleration assistance control, and the drift index.

12. The method of claim 11, wherein, in the determining the gain for the acceleration assistance control:
a vertical force ratio configured to indicate a rate of turn of the vehicle is determined from the vertical force of the left wheel, the vertical force of the right wheel, and the vehicle speed; and
the gain for the acceleration assistance control is determined by multiplying a control gain by the determined vertical force ratio.

13. The method of claim 9, wherein the determining a target yaw moment for the steering assistance control includes:
determining a drift target yaw rate based on the vehicle yaw rate detected, corrected, or estimated by a yaw rate sensor among the vehicle driving information;
determining a yaw rate control error which is a difference between the determined drift target yaw rate and the detected, corrected, or estimated vehicle yaw rate; and
determining a target yaw moment configured to cause the vehicle yaw rate to follow the drift target yaw rate based on the yaw rate error.

14. The method of claim 9, wherein, in the determining a target yaw for the yaw damping assistance control, the target yaw for the yaw damping assistance control is determined using the vehicle speed, a vehicle yaw rate detected by a yaw rate sensor, and a vehicle yaw acceleration obtained from the vehicle yaw rate or a lateral slip angle change rate among the vehicle driving information, as inputs.

15. The method of claim 14, wherein the determining the target yaw for the yaw damping assistance control includes:
determining a target yaw acceleration or a target lateral slip angle change rate which is a damping target corresponding to the vehicle speed;
determining a yaw acceleration error or a lateral slip angle change rate error based on the target yaw acceleration and the vehicle yaw acceleration, or the target lateral slip angle change rate; and
determining a target yaw moment configured to cause the vehicle yaw acceleration or the lateral slip angle change rate to follow the target yaw acceleration or the target lateral slip angle change rate based on the yaw acceleration error or the lateral slip angle change rate error.

16. The method of claim 15, further including:
determining, by the controller, a target wheel torque for the yaw damping assistance control,
wherein, in determining the target wheel torque for the yaw damping assistance control, a target wheel torque of a left wheel and a target wheel torque of a right wheel for the yaw damping assistance control are determined based on the vehicle yaw acceleration or the lateral slip angle change rate, the vehicle yaw rate, and the target yaw moment for the yaw damping assistance control.

17. The method of claim 9,
wherein a plurality of modes including a comfort mode and a sports mode configured to implement different degrees of drift at a same driver input in the acceleration assistance control and the steering assistance control is set in the controller, and
wherein the controller is configured to perform assistance control depending on a mode selected by a driver through an interface connected to the controller.

18. The method of claim 9, wherein the controller is provided so that through the interface connected to the controller, the controller is configured:
to receive a predetermined value tuned for the acceleration assistance control and the steering assistance control or a control value tuned for the driver input, by the driver, or
to receive set values tuned for each of modes configured to implement different degrees of drift at the same driver input or control values tuned for each of the modes at the driver input, by the driver.

19. The method of claim 9, wherein the controller is configured to perform yaw moment and wheel torque control of the vehicle using the vehicle driving information including driving force information of the vehicle in left and right wheel speed control and in the acceleration assistance control and the steering assistance control among the drift assistance control.

20. The method of claim 1, wherein, in the generating and outputting the target torque of the motor, the controller is configured to:
determine a target wheel torque of each wheel by distributing the determined target yaw moment into each wheel torque based on target driving force; and
determine a target torque of the motor configured for driving each wheel of the vehicle based on the target wheel torque.
